(19) United States
(12) Patent Application Publication
(10) Pub. No.: US 2013/0200744 A1
(43) Pub. Date: Aug. 8, 2013

(54) BRUSHLESS DC MOTOR AND METHOD FOR CONTROLLING THE SAME

(71) Applicants: Takeo Miyamura, Kobe-shi (JP); Kenichi Inoue, Kobe-shi (JP); Akira Tsutsui, Kobe-shi (JP); Hiroshi Hashimoto, Kobe-shi (JP); Hiroyuki Mitani, Kobe-shi (JP); Kyoji Zaitsu, Kobe-shi (JP)

(72) Inventors: Takeo Miyamura, Kobe-shi (JP); Kenichi Inoue, Kobe-shi (JP); Akira Tsutsui, Kobe-shi (JP); Hiroshi Hashimoto, Kobe-shi (JP); Hiroyuki Mitani, Kobe-shi (JP); Kyoji Zaitsu, Kobe-shi (JP)

(73) Assignee: KABUSHIKI KAISHA KOBE SEIKO SHO (Kobe Steel, Ltd.), Kobe-shi, Hyogo (JP)

(21) Appl. No.: 13/880,052

(22) PCT Filed: Oct. 4, 2011
(86) PCT No.: PCT/JP2011/005593

§ 371 Date: Apr. 18, 2013

(30) Foreign Application Priority Data
Nov. 9, 2010 (JP) 2010-250843

(51) Int. Cl. H02K 1/06; H02K 3/04; H02P 6/22

(52) U.S. Cl. CPC H02K 1/06; H02P 6/22; H02K 3/04
USPC 310/210; 310/216.067; 318/701

(57) ABSTRACT

This brushless DC motor (1) is provided with a stator (3) having a main body (312, 322) disposed on both ends thereof in the rotational axis direction with a single exciting coil (2) disposed between the main bodies (312, 322), and with a rotor (4) disposed in the interior of the stator (3), wherein main body (312) is formed with a first magnetic core (31) and main body (322) is formed with a second magnetic core (32), the magnetic cores (31, 32) functioning as a magnetic pole and having protrusions (311, 321), the quantity of which being different for each magnetic core (31, 32). The brushless DC motor (1) uses, as the driving force, the variation in the magnetic resistance between the stator (3) and the rotor (4) in relation to the flow of the magnetic flux generated in the periphery of the exciting coil (2). The method for controlling the brushless DC motor (1) of the present invention is a method for controlling the abovementioned brushless DC motor (1) in which starting coils (5 (5a, 5b)) each having a rectifier cell (52 (52a, 52b)) are disposed on the periphery of protrusion (321), wherein the rectifier cells (52) of the starting coils (5) impart, to the exciting coil (2), a pulse current having a polarity corresponding to the intended rotational direction, and having a start-up time and wave height that are sufficient for turning on.

### TECHNICAL FIELD

The present invention relates to a brushless DC motor and a method for controlling the brushless DC motor, and mainly relates to a motor that uses a dust core as an iron core and is driven by single-phase excitation.

### BACKGROUND ART

Motors are used in a wide variety of fields such as fields of automobiles, home appliances, and industrial applications as components that convert electrical power to mechanical power. Motors include a stator as a non-rotatable part and a rotor that is rotated together with an output shaft. Electromagnetic coils, magnets, and iron cores are provided in these components.

Motors are classified into a number of types in accordance with the structure and the principle of generating driving force. One of the types of motors that use permanent magnets is referred to as PM (Permanent Magnet) motors and used in a particularly wide variety of fields. In this PM motors, permanent magnets are provided in the rotor. A rotational force is generated by interaction between magnetic fluxes generated by electromagnetic coils provided in the stator and the permanent magnet.

Since motors are mechanical power sources, there has been a significant need for size reduction of motors. In order to reduce the size of motors, generation of larger magnetic force is needed. In order to obtain large magnetic force, a magnet that generates a large magnetic flux is needed. For example, Patent Literature 1 describes development of a magnet using Nd—Fe—B base elements (Nd; neodymium, Fe; iron, B; boron). However, expensive rare metals such as Dy (dysprosium) and Nd are necessary for these magnets. Large magnetic force (electromagnetic force) can be obtained also by increasing a magnetic field generated by an electromagnetic coil. As methods for increasing a magnetic field, increasing an exciting current and increasing the number of turns of an electromagnetic coil are effective. However, these methods have their own restrictions: the former is restricted by the sectional area of a coil and the latter is restricted by a space in which wire is wound.

Thus, nowadays, motors equipped with iron cores that use dust cores have been developed. The dust cores are formed through compaction and heat treatment after an electrically insulating coating has been formed on the surfaces of soft magnetic powder particles. Here, related-art motors use laminated magnetic cores formed by die cutting and stacking electromagnetic steel sheets. Since it is difficult for a magnetic flux to pass through the laminated magnetic core in the stacking direction and it is easy for a magnetic flux to pass through in the in-plane direction of a sheet, with the laminated magnetic cores, magnetic circuits are designed assuming that a magnetic flux passes through the in-plane direction. In contrast, since the above-described dust cores are formed by compacting soft magnetic powder, magnetic characteristics are isotropic. Thus, it can be said that, with the dust cores, three-dimensional design of a magnetic circuit is possible. Furthermore, since the dust cores can have an arbitrary shape through changes in the shape of dies used in compaction or through machining or the like performed on molded dust cores, the shape of the motor core can be diversified through three-dimensional magnetic design. This permits flat or compact motor design to be achieved.

Examples of size-reduced motors in which such dust cores are utilized are disclosed as, for example, claw teeth-type motors using three-dimensional magnetic circuits in Patent Literatures 2 to 4. According to these Patent Literatures 2 to 4, annular coils are disposed in claw pole-type iron cores instead of using a conventional technology where coils are wound around individual teeth. Thus, winding density is improved in the disclosed claw teeth-type motors, that is, size reduction can be achieved through improvement in magnetic force. Furthermore, since the dust cores are used, driving in an alternating current magnetic field is possible. Thus, by using a three-layer stator, layers of which are shifted from one another by 120° in terms of electrical angle, these disclosed claw teeth-type motors allow brushless drive in a three-phase magnetic field to be performed.

In the above-described Patent Literatures 2 to 4, claw-pole motors using dust cores are disclosed. Stators of such claw-pole motors have three-dimensional circuits in which dust cores with claw-shaped magnetic poles surround coils. However, since these disclosed claw-pole motors use a three-phase current source, three stators are arranged in the rotational axis direction and a current phase is assigned to each of the stators. For this reason, these claw-pole motors need to have three-layer structure in which a dust core stator is provided for each phase. In order to reduce the size of the disclosed motors, the thickness of the stator needs to be reduced, that is, the thickness of the dust core needs to be reduced to at least three times smaller. Thus, a sufficient strength of the dust cores is not necessarily maintained (the dust core may become fragile).

In order to maintain the strength of the dust cores, the size (thickness) of the component shape needs to be increased. Thus, a single-phase exciting type motor having a single stator is needed. Here, in order to sufficiently utilize magnetic force generated in the coil, the stator desirably includes salient poles. However, with a single-phase excitation using a salient pole magnetic core, a rotating magnetic field is not generated, and accordingly, torque for rotating the rotor is not obtained. With the shapes of the magnetic cores disclosed in Patent Literatures 2 to 4, a large part of a magnetic flux that is generated in and extends around the coil does not contribute as rotational torque, and only a leakage magnetic flux in a peripheral direction, the leakage magnetic flux flowing between upper and lower teeth engaged with one another, can be utilized for torque. Thus, the magnetic flux cannot be effectively utilized.

Conventionally used SR (switched reluctance) motors are an example of motors that do not use permanent magnets. The SR motors utilize reluctance torque caused by variation in magnetic resistance due to rotation. In the SR motors, coils of a stator are sequentially energized (switched) as salient poles of a rotor approach the coils, thereby the rotor is rotated. Accordingly, there is an advantage in that the cost of the SR motors, which do not use magnets in the rotors, is low. Furthermore, since there is no problem of thermal demagnetization of magnets, there also is an advantage in that the SR motors can be operated at higher temperature compared to the PM motors. However, the SR motors are not rotated by a single-phase, and accordingly, the SR motors need to have a multilayer structure or a polyphase structure.

### CITATION LIST

### Patent Literature

PTL 1: Japanese Unexamined Patent Application Publication No. 2009-43776

PTL 2: Japanese Unexamined Patent Application Publication No. 2006-333545

PTL 3: Japanese Unexamined Patent Application Publication No. 2007-325373

PTL 4: Japanese Unexamined Patent Application Publication No. 2009-142086

### SUMMARY OF INVENTION

The present invention is proposed in view of the above-described situation. An object of the present invention is to provide a brushless DC motor and a method for controlling the brushless DC motor. This brushless DC motor can realize a motor that has a three-dimensional magnetic circuit provided with an electromagnetic coil and a single stator having salient poles. In this brushless DC motor, magnetic force can be more effectively utilized.

A brushless DC motor according to the present invention includes a stator that includes main bodies disposed on one and the other side of a single exciting coil in a rotational axis direction, and a rotor provided inside the stator. In the brushless DC motor, first and second magnetic cores that each have protrusions serving as magnetic poles are formed in the main bodies of the stator, and the numbers of the protrusions of the first and second magnetic cores are different from each other. In the brushless DC motor, variation in magnetic resistance between the stator and the rotor with respect to a flow of a magnetic flux generated around the exciting coil is used as a driving force. A method for controlling a brushless DC motor according to the present invention is a method for controlling the above-described brushless DC motor in which an induction coil that includes a loop-shaped conducting member and a rectifier cell arranged in the conducting member is provided around each of the protrusions of the second magnetic core. The method includes providing the exciting coil with a pulse current that has a start-up time and a wave height that are sufficient to cause the rectifier cells of the induction coils to be turned on and that has a polarity corresponding to an intended rotational direction. The brushless DC motor having such a structure and the method for controlling the brushless DC motor have a three-dimensional magnetic circuit provided with an electromagnetic coil and a single stator having the salient poles and allow magnetic force to be more effectively utilized.

Objects including the above-described object, features, and advantages of the present invention will be better understood from the following detailed description with reference to the accompanying drawings.

### BRIEF DESCRIPTION OF DRAWINGS

FIG. 1 is a perspective view of a brushless DC motor according to an embodiment with part of the brushless DC motor removed.

FIG. 2 is a sectional view of the brushless DC motor illustrated in FIG. 1 taken along an axial direction.

FIG. 3 is a sectional view of the brushless DC motor illustrated in FIG. 1 taken in a direction perpendicular to the axis at the position of a first magnetic core.

FIG. 4 is a sectional view of the brushless DC motor illustrated in FIG. 1 taken in a direction perpendicular to the axis at the position of a second magnetic core.

FIG. 5 includes perspective views illustrating the structure of starting coils of the brushless DC motor illustrated in FIG. 1.

FIG. 6 illustrates an equivalent circuit of the brushless DC motor illustrated in FIG. 1.

FIG. 7 is a graph illustrating the relationship between a current and a voltage applied to a rectifier cell provided in the starting coil of the brushless DC motor illustrated in FIG. 1.

FIG. 8 is a diagram of a result of a magnetic field analysis illustrating flows of a magnetic flux generated when the exciting coil of the brushless DC motor 1 illustrated in FIG. 1 is energized.

FIG. 9 illustrates a calculation result of inductance in accordance with rotation when the numbers of the magnetic poles of a rotor and the first magnetic core are four, the number of the magnetic poles of the second magnetic core is eight, and a magnetic pole width is 50% with respect to the period of the magnetic pole of the rotor.

FIG. 10 illustrates a calculation result of inductance in accordance with rotation when the numbers of the magnetic poles of the rotor and the first magnetic core are four, the number of the magnetic poles of the second magnetic core is eight, and the magnetic pole width is 55% with respect to the period of the magnetic pole of the rotor.

FIG. 11 illustrates a calculation result of inductance in accordance with rotation when the numbers of the magnetic poles of the rotor and the first magnetic core are four, the number of the magnetic poles of the second magnetic core is eight, and the magnetic pole, width is 60% with respect to the period of the magnetic pole of the rotor.

FIG. 12 illustrates a calculation result of inductance in accordance with rotation when the numbers of the magnetic poles of the rotor and the first magnetic core are four, the number of the magnetic poles of the second magnetic core is eight, and the magnetic pole width is 65% with respect to the period of the magnetic pole of the rotor.

FIG. 13 illustrates a calculation result of inductance in accordance with rotation when the numbers of the magnetic poles of the rotor and the first magnetic core are four, the number of the magnetic poles of the second magnetic core is eight, and the magnetic pole width is 70% with respect to the period of the magnetic pole of the rotor.

FIG. 14 illustrates variation in inductance in accordance with rotation when the numbers of the magnetic poles of the rotor and the first magnetic core are four, the number of the magnetic poles of the second magnetic core is eight, the magnetic pole width is 60% with respect to the period of the magnetic pole of the rotor, and, in the two magnetic cores of a stator, the magnetic poles of the second magnetic core are shifted by ±11.25° with respect to the magnetic poles of the first magnetic core.

FIG. 15 illustrates variation in inductance in accordance with rotation when the numbers of the magnetic poles of the rotor and the first magnetic core are four, the number of the magnetic poles of the second magnetic core is eight, the magnetic pole width is 60% with respect to the period of the magnetic pole of the rotor, and, in the two magnetic cores of the stator, the magnetic poles of the second magnetic core are shifted by ±16.9° with respect to the magnetic poles of the first magnetic core.

FIG. 16 illustrates variation in inductance in accordance with rotation when the numbers of the magnetic poles of the rotor and the first magnetic core are four, the number of the magnetic poles of the second magnetic core is eight, the magnetic pole width is 60% with respect to the period of the magnetic pole of the rotor, and, in the two magnetic cores of the stator, the magnetic poles of the second magnetic core are shifted by ±25° with respect to the magnetic poles of the first magnetic core.

FIG. 17 illustrates variation in inductance in accordance with rotation when the numbers of the magnetic poles of the rotor and the first magnetic core are two, and the number of the magnetic poles of the second magnetic core is four.

FIG. 18 illustrates variation in inductance in accordance with rotation when the numbers of the magnetic poles of the rotor and the first magnetic core are three, and the number of the magnetic poles of the second magnetic core is six.

FIG. 19 illustrates variation in inductance in accordance with rotation when the numbers of the magnetic poles of the rotor and the first magnetic core are five, and the number of the magnetic poles of the second magnetic core is ten.

FIG. 20 illustrates variation in inductance in accordance with rotation when the numbers of the magnetic poles of the rotor and the first magnetic core are six, and the number of the magnetic poles of the second magnetic core is 12.

FIG. 21 is a block diagram illustrating an example of the configuration of a drive circuit of the brushless DC motor illustrated in FIG. 1.

FIG. 22 illustrates drive control operation in accordance with rotation.

FIG. 23 illustrates a method for starting the brushless DC motor using the drive circuit illustrated in FIG. 21.

### DESCRIPTION OF EMBODIMENTS

An embodiment according to the present invention will be described below with reference to the drawings. In the drawings, components denoted by the same reference signs indicate the same components and description thereof is adequately omitted. Herein, components are generally denoted by the respective reference signs without indices and are particularly denoted by the respective reference signs with indices.

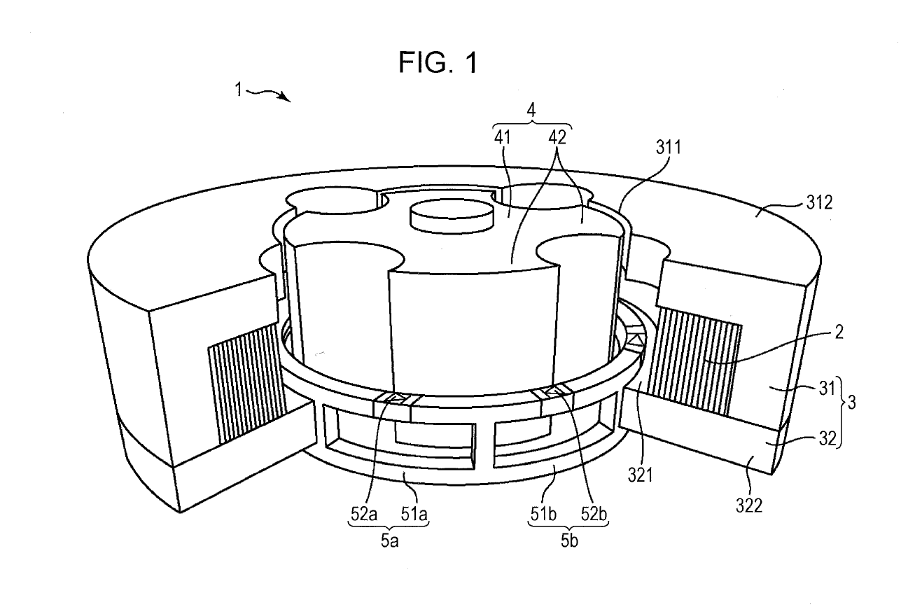

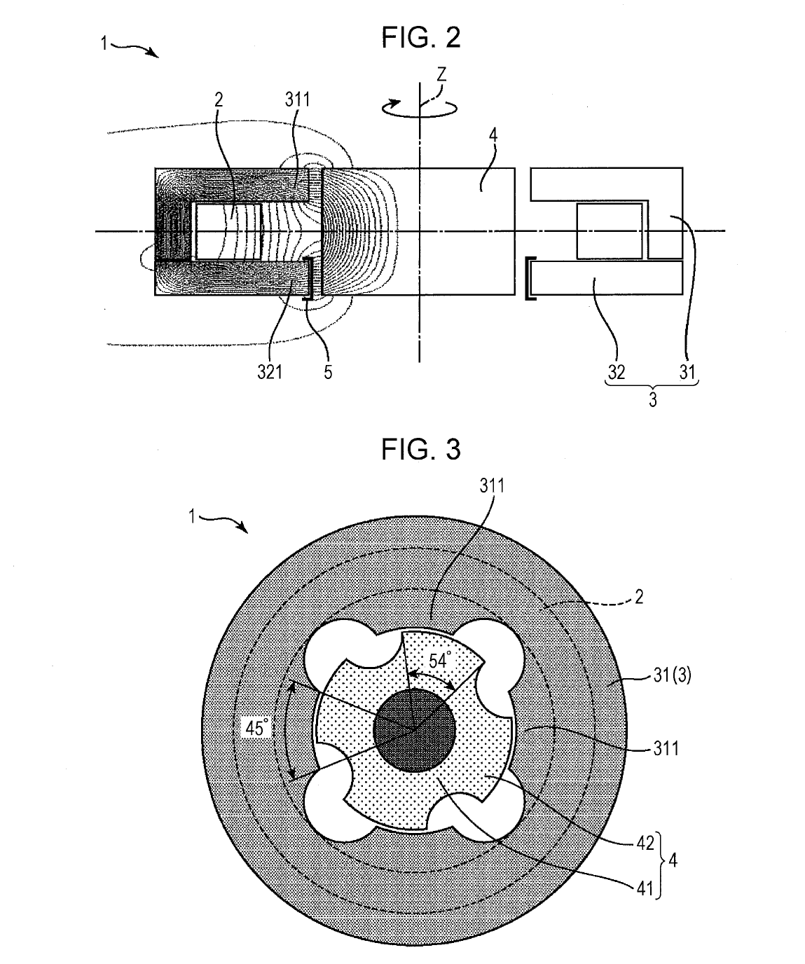

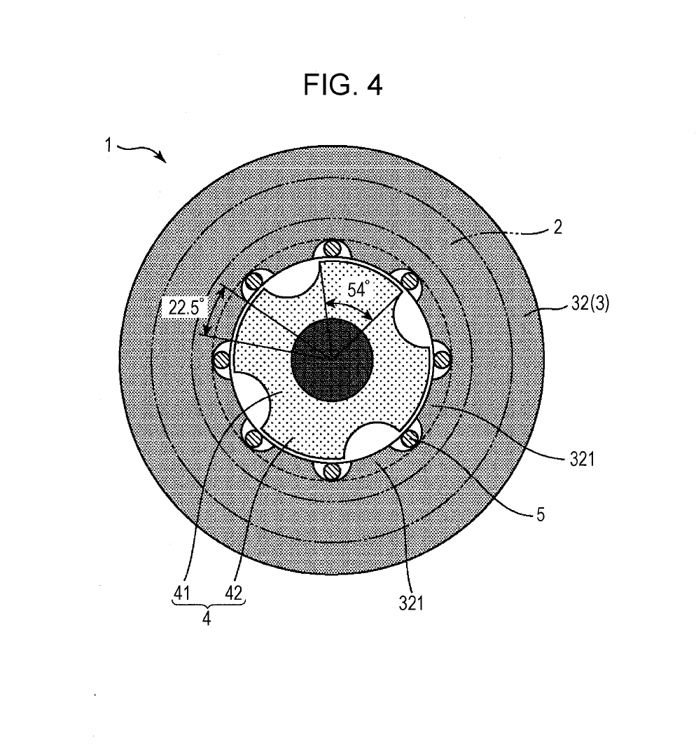

FIG. 1 is a perspective view of a brushless DC motor 1 according to an embodiment with part of the brushless DC motor 1 removed. FIG. 2 is a sectional view of the brushless DC motor 1 taken in an axial direction. FIG. 3 is a sectional view of the brushless DC motor 1 taken in a direction perpendicular to the axis at the position of a first magnetic core 31. FIG. 4 is a sectional view of the brushless DC motor 1 taken in the direction perpendicular to the axis at the position of a second magnetic core 32.

The brushless DC motor 1 generally includes a stator 3, a rotor 4, and starting coils 5 (5a and 5b). The stator 3 has a single exciting coil 2. The rotor 4 is an inner rotor and disposed coaxially with the stator 3 inside the stator 3. The brushless DC motor 1 performs SR operation using as a driving force variation in magnetic resistance between the stator 3 and the rotor 4 with respect to a flow of a magnetic flux generated around the exciting coil 2. In order to realize the brushless DC motor 1 with a single exciting coil 2 as described above, the following structure is adopted.

When a rotating magnetic field is not generated, the single exciting coil 2 in a quiescent state does not necessarily obtain torque depending on the rotational angle, and accordingly, the brushless DC motor 1 cannot perform self-starting. That is, an SR motor (switched reluctance motor), which rotates using variation in magnetic resistance as the driving force, cannot obtain torque at a rotational angle position where variation in magnetic resistance does not exist. While being rotated, for example, at a certain speed, the motor at a rotational angle where torque is not obtained can still rotate due to inertia. However, when the motor is in the quiescent state, the motor cannot start at a rotational angle where torque is not obtained.

For this reason, the SR motor is equipped with salient poles (magnetic poles) in both of its rotor and stator. In such a brushless DC motor 1, the rotor 4 has, as is the case with a usual SR motor, a base portion 41 and a plurality (four in an example illustrated in FIGS. 1 to 4) of protrusions 42. The protrusions 42, which serve as the magnetic poles, radially extend outward from the base portion 41 so as to be equally spaced in the peripheral direction.

The stator 3 includes the first magnetic core 31 and the second magnetic core 32. The first magnetic core 31 and the second magnetic core 32 are disposed on one and the other side of the exciting coil 2 in the rotational axis Z direction. In these first and second magnetic cores 31 and 32, the number of protrusions 311, which serve as the magnetic poles, of the first magnetic core 31 and the number of protrusions 321, which serve as the magnetic poles, of the second magnetic core 32 are set to be different from each other. This allows the brushless DC motor 1 to drive with the single exciting coil 2. For example, in the example illustrated in FIGS. 1 to 4, the number of the protrusions 311 of the first magnetic core 31 is four, which is the same as the number of the protrusions 42 of the rotor 4, and the number of the protrusion 321 of the second magnetic core 32 is eight, which is twice the number of the protrusions 311 of the first magnetic core 32. The first and second magnetic cores 31 and 32 respectively have annular main bodies 312 and 322. The plurality of protrusions 311 and the plurality of protrusions 321 radially extend inward from the main body 312 and 322 so as to be formed in the peripheral direction.

In the case of a usual claw-teeth motor, claw-poles that extend in the axial direction are regularly alternatingly arranged so as to be side by side with one another in the two magnetic cores 31 and 32 disposed on both the sides of the exciting coil 2 in the rotational axis Z direction, and the magnetic flux flows in the diametrical direction through the rotor. In the present embodiment, the protrusions 311 and 321, which serve as the magnetic poles, are salient poles that radially extend inward from the annular main bodies 312 and 322. Thus, as illustrated in FIG. 2, the magnetic flux flows from the protrusion 311 (321) of the first magnetic core 31 (second magnetic core 32) into the rotor 4 through to the protrusion 321 (311) of the second magnetic core 32 (first magnetic core 31) from the side of the rotor 4 into which the magnetic flux has flowed. Since the number of the protrusions 311 of the first magnetic core 31 and the number of the protrusions 321 of the second magnetic core 32 are different from each other, even in the brushless DC motor 1 having the single exciting coil 2, with which a rotating magnetic field is not generated, rotational torque is generated in the peripheral direction at a position or positions between magnetic poles, thereby allowing the brushless DC motor 1 to be driven with the single exciting coil 2.

Thus, the brushless DC motor 1, which has a compact and simple structure with the single exciting coil 2 and the stator 3 and can be driven by single-phase excitation, is realized. In order to perform SR operation, even when the brushless DC motor 1 is driven by single-phase excitation, the magnetic poles of the stator 3 can serve as salient poles, which allow the magnetic flux to be effectively utilized. Thus, efficiency can be improved. Since the brushless DC motor 1 has a simple structure, productivity with which the brushless DC motor 1 is produced is high. In the SR motor, variation in magnetic resistance between the rotor 4 and the stator 3 is used as the driving force as described above, and accordingly, torque required for rotation of the rotor 4 can be obtained without a permanent magnet. Thus, in brushless DC motors, which are essential power sources in industrial and consumer fields, rare metals of rare earth magnets and the like can be conserved.

Table 1 shows the result of comparison between the brushless DC motor 1 according to the present embodiment and several types of related-art motors.

TABLE 1

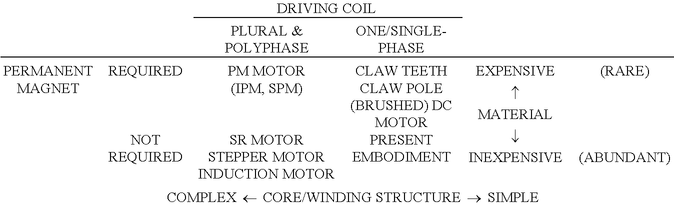

That is, the brushless DC motor 1 according to the present embodiment performs operation of an SR motor, which does not need a permanent magnet and is produced with inexpensive materials. In addition, as is the case with a claw-teeth motor or a claw-pole motor, the brushless DC motor 1 requires a single exciting coil. Thus, in the brushless DC motor 1 according to the present embodiment, the structures of windings and cores can be simplified.

As described above, in the brushless DC motor 1 according to the present embodiment, the numbers of protrusions 311 and 321 of the first and second magnetic cores 31 and 32 are different from each other. This allows rotational torque to be generated in the peripheral direction between magnetic poles of either of the magnetic cores 31 and 32. In the brushless DC motor 1 according to the present embodiment, by setting the number of the protrusions 311 of the first magnetic core 31 to be the same as the number of the protrusions 42 of the rotor 4, comparatively uniform rotational torque can be generated.

In this case, when the protrusions 42 of the rotor 4 stop at middle positions between the protrusions 321 of the second magnetic core 32, it may be difficult to start the brushless DC motor 1 depending on the positions of the protrusions 311 of the first magnetic core 31. For this reason, a starting coil 5, which is an induction coil, is provided around each of the protrusions 321 of the second magnetic core 32. The starting coils 5 include loop-shaped conducting members 51 and rectifier cells 52 arranged in the middle of each conducting member 51. The rectifier cells 52 are arranged so that the rectifier cells 52 of adjacent magnetic poles limit the flow of current in directions opposite to each other.

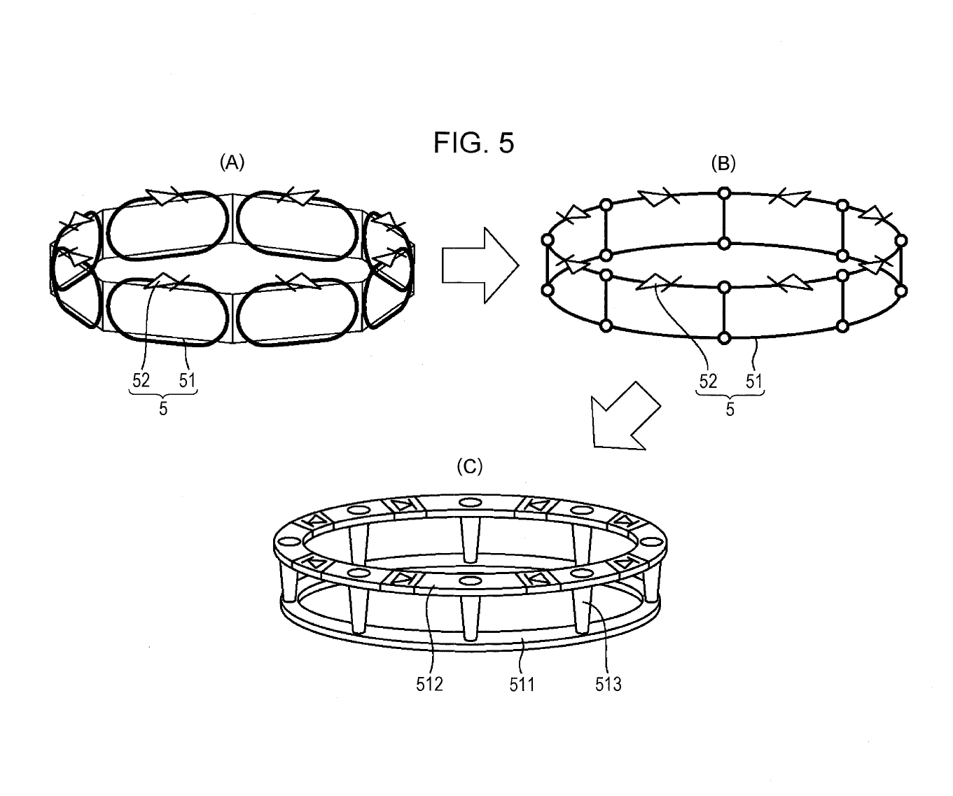

FIG. 5 schematically illustrates the structure of the starting coils 5. View (A) of FIG. 5 illustrates a basic structure of the above-described starting coils 5. View (B) of FIG. 5 illustrates that the starting coils 5 illustrated in view (A) of FIG. 5, the starting coils 5 being coils independently wound for the respective poles, are equal to a circuit formed by a ladder-shaped network with the rectifier cells 52 disposed at one of the side rails of the ladder shape so that the rectifier cells 52 of opposite polarities are arranged adjacent to each other. More specifically, the circuit illustrated in view (B) of FIG. 5 is implemented by using, for example, a structure illustrated in view (C) of FIG. 5. That is, as illustrated in view (C) of FIG. 5, an example of an actual structure of the starting coils 5 has an integrated cage-shaped structure, which has a single annular conducting member 511, a generally annular closed circuit 512, and conducting columns 513. The closed circuit 512 includes the rectifier cells 52, which are connected in series to one another such that the rectifier cells 52 of opposite poles are adjacent to each other. The annular conducting member 511 and the closed circuit 512 oppose each other and are connected to each other with the conducting columns 513 therebetween, thereby the ladder shape is formed. View (B) of FIG. 5 illustrates that effects equal to those obtained by the basic structure illustrated in view (A) of FIG. 5 can also be obtained by the structure illustrated in view (C) of FIG. 5.

The rectifier cells 52 are arranged in the closed circuit 512 between the first and second magnetic cores 31 and 32. There is an alternating-current magnetic flux that passes through the rotor 4 in the closed circuit 512 interposed between the first and second magnetic cores 31 and 32. This generates an induced electromotive force in the closed circuit 512. For this reason, when the rectifier cells 52 are arranged on the annular conducting member 511 side, an induced current is generated on the closed circuit 512 side, thereby causing a situation in which a motor driving force intended in the present embodiment is not generated.

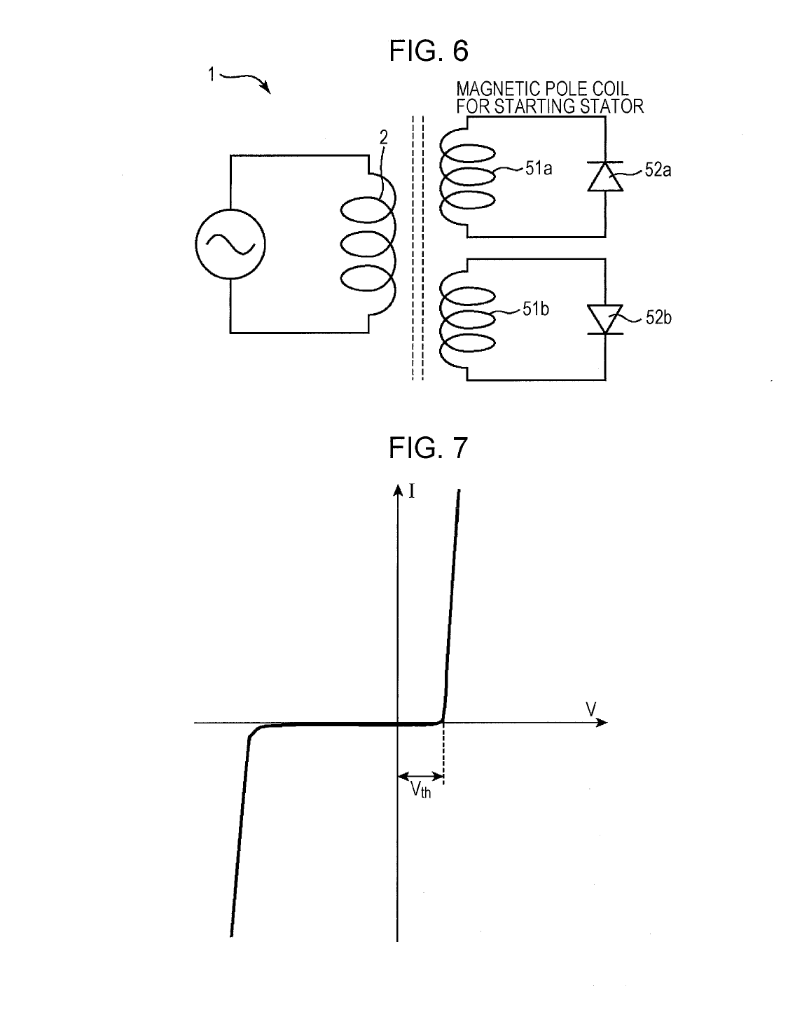

FIG. 6 illustrates an equivalent circuit of the brushless DC motor 1 according to the present embodiment having the above-described structure. In motor control, which will be described later, in such a case where rotation of the motor is started, when current pulses that quickly rise and having a large wave height flow through the exciting coil 2, lines of magnetic flux corresponding to the current pulses flow from the first magnetic core 31 (second magnetic core 32) of the stator 3 into the second magnetic core 32 (first magnetic core 31) of the stator 3 through the rotor 4. In this case, induced electromotive forces corresponding to the ratio of change in the lines of magnetic induction are generated in conducting members 51a or 51b of two types of the starting coils 5a and 5b in accordance with the polarities of rectifier cells 52a and 52b wound around the salient poles of the second magnetic core 32. Such starting coils 5a and 5b are examples of induction coils.

Here, the rectifier cells 52a and 52b, which are based on P-N junction of semiconductor, have characteristics as illustrated in FIG. 7. Thus, when the polarity of the induced electromotive force is in the forward direction of the rectifier cell 52a or 52b and larger than the threshold value (Vth), the rectifier cells 52a or 52b is turned on and an induction current is induced in the conducting member 51a or 51b. When the polarities of the induced electromotive force is in the reverse direction of the rectifier cell 52a or 52b, or the induced electromotive force is equal to or smaller than the rating of the rectifier cell 52a or 52b, the rectifier cell 52a or 52b remain turned off and no induction current is generated.

Thus, as described above, when current pulses that have a sufficient start-up time and has a sufficient wave height flow through the exciting coil 2, the induction current flows through one of the two types of starting coils 5a and 5b and a diamagnetic field is generated in the magnetic pole where the one of the starting coils 5a and 5b is wound. Thus, the lines of magnetic induction having flowed are attenuated. In contrast, the induction current does not flow through the other of the two types starting coils 5a and 5b, and the lines of magnetic induction having flowed are not affected.

Here, in the case where the number of the protrusions 321 of the second magnetic core 32 is twice the number of the protrusions 311 of the first magnetic core 31, and in particular, as illustrated in FIGS. 3 and 4, when pairs of the protrusions 321 of the second magnetic core 32 are equally shifted in the peripheral direction relative to the corresponding one of the protrusions 311 of the first magnetic core 31 at the center, more uniform rotational torque can be generated. In this case, when the protrusions 42 of the rotor 4 stop so as to face the protrusions 311 of the first magnetic core 31, that is, the protrusions 42 stops at positions between the pairs of protrusions 321 of the second magnetic core 32, a lines of magnetic induction having flowed from one of the magnetic poles of the first magnetic core 31 flow into the protrusion 42 of the rotor 4, pass through the rotor 4 in the substantially axial direction, and then are divided and flow into two of the protrusions 321 equally spaced apart from the axis of the protrusion 42. In this situation, it is difficult for the brushless DC motor 1 to be started.

Thus, the above-described starting coils 5 are provided and excited by current pulses that have a sufficient start-up time and a sufficient wave height. This causes a loop current to flow through the magnetic pole on the starting coil side where the rectifier cell 52 is turned on, and the induced excitation magnetic flux cannot flow because of the diamagnetic flux. The induced excitation magnetic flux flows only into the magnetic pole on the starting coil 5 side where the rectifier cell 52 remains turned off. It is easily understood that, by inverting the polarity of the current pulse, functions performed by the above-described two types of the induction coils are changed to each other. Thus, by selecting the polarity of the current pulses for starting, the rotor 4 can be started to rotate in an intended rotational direction.

Thus, as described above, even when the protrusions 42 of the rotor 4 are stopped between the protrusions 321 of the second magnetic core 32, unbalanced magnetic field is generated between the rotor 4 and a pair of protrusions 321 of the second magnetic core 32. This can prevent variation in the magnetic resistance from becoming uniform in the brushless DC motor 1 according to the present embodiment. Thus, even with a combination of a single exciting coil 2 and the stator 3, an SR motor that can perform self-starting is realized. Since the starting coils 5 are integrated into a cage-shaped structure as described above, the starting coils 5 can be wound around the second magnetic core 32 by, in a state in which one of annular members, that is, the annular conducting member 511 and the closed circuit 512, is detached, fitting the starting coils 5 onto the second magnetic core 32 and then by joining the one of the annular members to the conducting columns 513. This facilitates the assembly of the brushless DC motor 1.

As illustrated in FIG. 1, in the brushless DC motor 1 according to the present embodiment, the exciting coil 2 is formed by winding a band-like conducting member flatwise so that the width direction of the conducting member extends in the rotational axis Z direction of the exciting coil 2. In general, when a coil is energized, since a coil is formed of a conducting member, eddy currents are generated in a plane perpendicular to lines of magnetic force (orthotomic surface), thereby causing losses. The magnitude of the eddy currents is, when the magnetic flux density is uniform, proportional to the area of portions that intersect the lines of magnetic induction, that is, a continuous plane perpendicular to the lines of magnetic induction. Since the lines of magnetic induction extend in the axial direction in a coil, eddy currents are proportional to the area of a plane in the radial direction, which is perpendicular to the axial direction of the conducting member of the coil. Thus, in the band-like conducting member of the exciting coil 2, the ratio t/W of the radial thickness t to the width W is preferably equal to or smaller than 1/10.

With such a structure, the eddy currents are suppressed, and accordingly, generation of heat is suppressed. Furthermore, since the band-like conducting member can be wound without gaps, compared to the case where a cylindrical element wire is wound, current density can be increased and heat dissipation from the inside of the conducting member is desirable. Eddy current losses can be further reduced when the thickness t of the conducting member is equal to or smaller than the skin thickness corresponding to the frequency of alternating current power supplied to the motor. The skin thickness δ is generally represented by the following equation: δ=(2/ωμρ)^{1/2} where ω is the angular frequency of the alternating current power, μ is the magnetic permeability of the conducting member, and ρ is the electrical conductivity of the conducting member.

In the thus structured brushless DC motor 1, the gaps formed between the exciting coil 2 and the two magnetic cores 31 and 32 of the stator 3 are preferably filled with a thermally conductive member. With such a structure, heat generated in the exciting coil 2 can be effectively transferred to the two magnetic cores 31 and 32, which surround the exciting coil 2, through the thermally conductive member. Thus, a heat dissipation property can be improved.

In the thus structured brushless DC motor 1, an inner surface of the first magnetic core 31 of the stator 3, the inner surface being a surface that opposes one end portion of the exciting coil 2 in the rotational axis Z direction, is preferably parallel to an inner surface of the second magnetic core 32 that opposes the other end portion of the exciting coil 2 at least in a region where the first and second magnetic cores 31 and 32 cover the end portions of the exciting coil 2. This structure is to maximize the effects of setting the above-described conditions for the exciting coil 2 (wound flatwise and the width W is larger than the thickness t). In the case where the above-described conditions for the exciting coil 2 are set, when the first and second magnetic cores 31 and 32 that cover the upper and lower end surfaces of the exciting coil 2 are inclined to each other, lines of magnetic induction (lines of magnetic force) that actually pass through the exciting coil 2 are not substantially parallel to the rotational axis Z direction near the upper and lower end surfaces. Thus, the effects of setting the above-described conditions for the exciting coil 2 are not maximized.

The inventor of the present invention checked the distribution of lines of magnetic induction with the parallelism of inner wall surfaces of the two magnetic cores 31 and 32 changed. As a result, when the parallelism was, for example, 1/100, the lines of magnetic induction passing through the exciting coil 2 were parallel to the rotational axis Z direction. When the parallelism was − 1/10 or 1/10, the lines of magnetic induction passing through the exciting coil 2 were not parallel to the rotational axis Z direction. According to the results of the above-described checking, in order to cause the lines of magnetic induction passing through the exciting coil 2 to be parallel to one another, the absolute value of the parallelism is preferably equal to or smaller than 1/50.

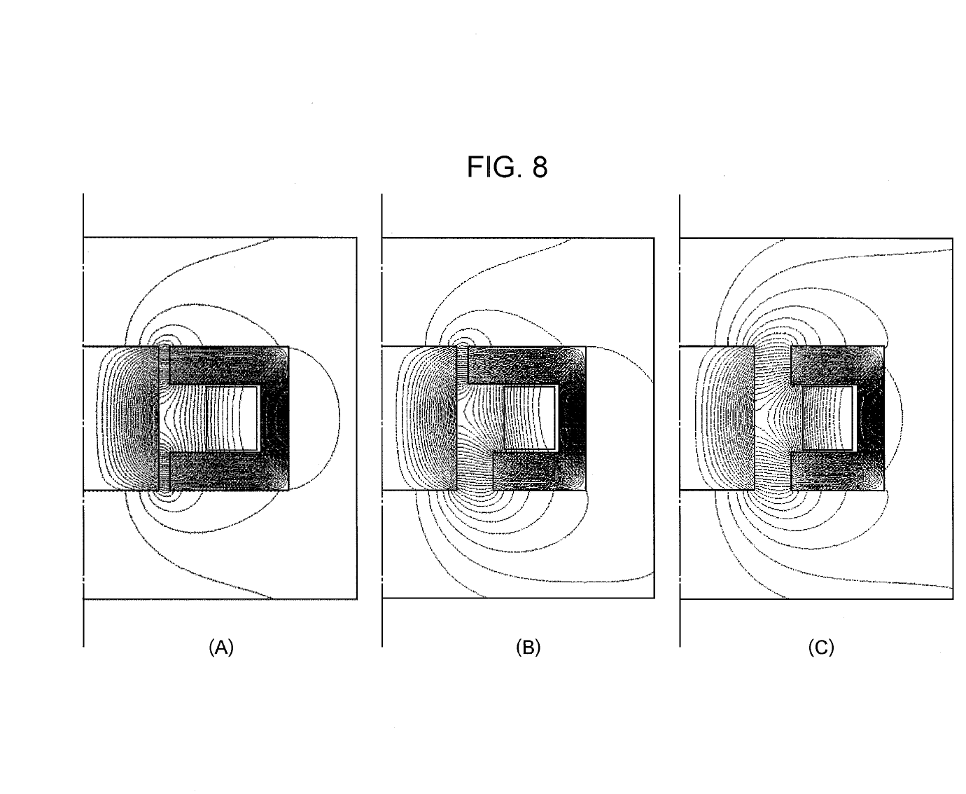

Here, a magnetic circuit may be geometrically deformed by variation in the gaps between the rotor 4 and the stator 3 due to presence/absence of the magnetic poles of the rotor 4 and the stator 3. However, according to a magnetic field analysis performed by the inventor of the present invention, as illustrated in FIG. 8, it has been confirmed that the form of the lines of magnetic induction passing through the exciting coil 2 are not significantly affected (ensured that the lines of magnetic induction are parallel to the band-like conducting member). In FIG. 8, view (A) illustrates a basic form in which both the protrusions 311 and 321 of the stator 3 protrude toward the rotor 4 side and the sizes of the gaps are small. View (B) of FIG. 8 illustrates the result of the magnetic field analysis in which the size of one of the gaps is increased. View (C) of FIG. 8 illustrates the result of the magnetic field analysis in which the sizes of both the gaps are increased.

In the brushless DC motor 1 according to the present embodiment, the first and second magnetic cores 31 and 32 and the rotor 4 are preferably formed of one of the following magnetic cores: a dust core formed of an iron-based soft magnetic powder having a magnetic isotropy, a ferrite magnetic core, and a magnetic core formed of a soft magnetic material formed by dispersing particles of a soft magnetic alloy powder in a resin. With such a structure, the magnetic core of the rotor 4 and two magnetic cores of the stator 3 can be formed into respective optimum shapes even when the shapes are complex. Thus, desired magnetic characteristics can be comparatively easily obtained and desired shapes can be comparatively easily formed.

The soft magnetic powder is a ferromagnetic metal powder. More specifically, examples of the soft magnetic powder include a pure iron powder, an iron-based alloy powder (Fe—Al alloy, Fe—Si alloy, sendust, permalloy, or the like), an amorphous powder, an iron powder having an electrically insulating coating such as a phosphate chemical conversion coating formed on the surfaces of the powder particles, and the like. These soft magnetic powders can be produced by, for example, a microparticulation method using an atomization method or the like, or a method in which iron oxide or the like is finely ground and then reduced.

Such soft magnetic powders each can be used by itself or mixed with a non-magnetic powder such as the above-described resin. In the case of mixture, the mixing ratio can be comparatively easily adjusted. By appropriately adjusting the ratio of mixture, desirable magnetic characteristics of the magnetic core material can be easily obtained. The rotor 4 in addition to the two magnetic cores 31 and 32 of the stator 3 are preferably formed of the same raw material from a viewpoint of cost reduction.

In the brushless DC motor 1 according to the present embodiment, in at least one of the first and second magnetic cores 31 and 32 (31 in FIGS. 1 and 2), the main body 312 has an L-shaped section in the peripheral direction. With such a structure, assembly of the brushless DC motor 1 can be performed only by fitting the exciting coil 2 into the L-shaped structure.

Next, with respect to magnetic pole widths of the stator 3 and the rotor 4, that is, with respect to the cylindrical planes defined by loci of the tips of the protrusions 311, 321, and 42, optimum ranges of lengths (=areas) of the tips in the peripheral direction are described below. Torque F·δx(=N·δθ) generated in the motor structure according to the present embodiment is proportional to the ratio of variation ∂L (θ)/∂θ in inductance L to a rotational angle θ of the rotor 4, the ratio of variation being a ratio approximated from a model magnetic circuit shown below.

$$\begin{matrix}F \cdot δ x = N \cdot δθ \\ = Δ E \\ = \frac{\partial }{\partial θ} ( \frac{1}{2} {L}_{( θ )} {I}^{2} ) \cdot δθ \\ = \frac{1}{2} {I}^{2} \frac{\partial {L}_{( θ )}}{\partial θ} \cdot δθ ⇒ N ∝ \frac{\partial {L}_{( θ )}}{\partial θ}\end{matrix} \qquad [ Math . 1 ]$$

Here, an approximation model is used. In the approximation model, the gap (g) between the magnetic poles of the stator 3 and the rotor 4 is sufficiently small and the lines of magnetic induction pass through only regions where the magnetic poles are superposed with one another. In this case, the inductance of a magnetic circuit equivalent to the present motor structure is inversely proportional to a series magnetic resistance formed of the magnetic resistance between the first magnetic core 31 and the rotor 4 and the magnetic resistance between the second magnetic core 32 and the rotor 4. Thus, the following approximated expression is obtained.

$${L}_{( θ , φ )} ∝ \frac{1}{\frac{{g}_{upper}}{{S}_{upper ( θ )}} + \frac{{g}_{lower}}{{S}_{lower ( θ , φ )}}} \approx \frac{1}{g ( \frac{1}{{S}_{upper ( θ )}} + \frac{1}{{S}_{lower ( θ , φ )}} )} ∝ \frac{{S}_{upper ( θ )} \times {S}_{lower ( θ , φ )}}{{S}_{upper ( θ )} + {S}_{lower ( θ , φ )}} \qquad [ Math . 2 ]$$

where S_{u/1} is area of regions where salient poles of rotor and stator superposed.

$$Δ L ≡ {L}_{max} - {L}_{min} , \\ \frac{Δ L}{2 L} ≡ \frac{{L}_{max} - {L}_{min}}{{L}_{max} + {L}_{min}} [ \% ]$$

Here, gᵤₚₚₑᵣ denotes the length of the gap between the protrusion (magnetic pole) 311 of the first magnetic core 31 and the protrusion (magnetic pole) 42 of the rotor 4; g_{lower} denotes the length of the gap between the protrusion (magnetic pole) 321 of the second magnetic core 32 and the protrusion (magnetic pole) 42 of the rotor 4; Sᵤₚₚₑᵣ (θ) denotes the area where opposing surfaces of the protrusions (magnetic poles) 311 of the first magnetic core 31 and the protrusions (magnetic poles) 42 of the rotor 4 are superposed one another; and S_{lower} (θ) denotes the area where opposing surfaces of the protrusions (magnetic poles) 321 of the second magnetic core 32 and the protrusions (magnetic poles) 42 of the rotor 4 are superposed with one another.

That is, the area where the magnetic poles are superposed one another is the inductance, and the size of torque can be approximately estimated by the difference ΔL, which is the difference between a maximum Lmax and a minimum Lmin of the inductance L.

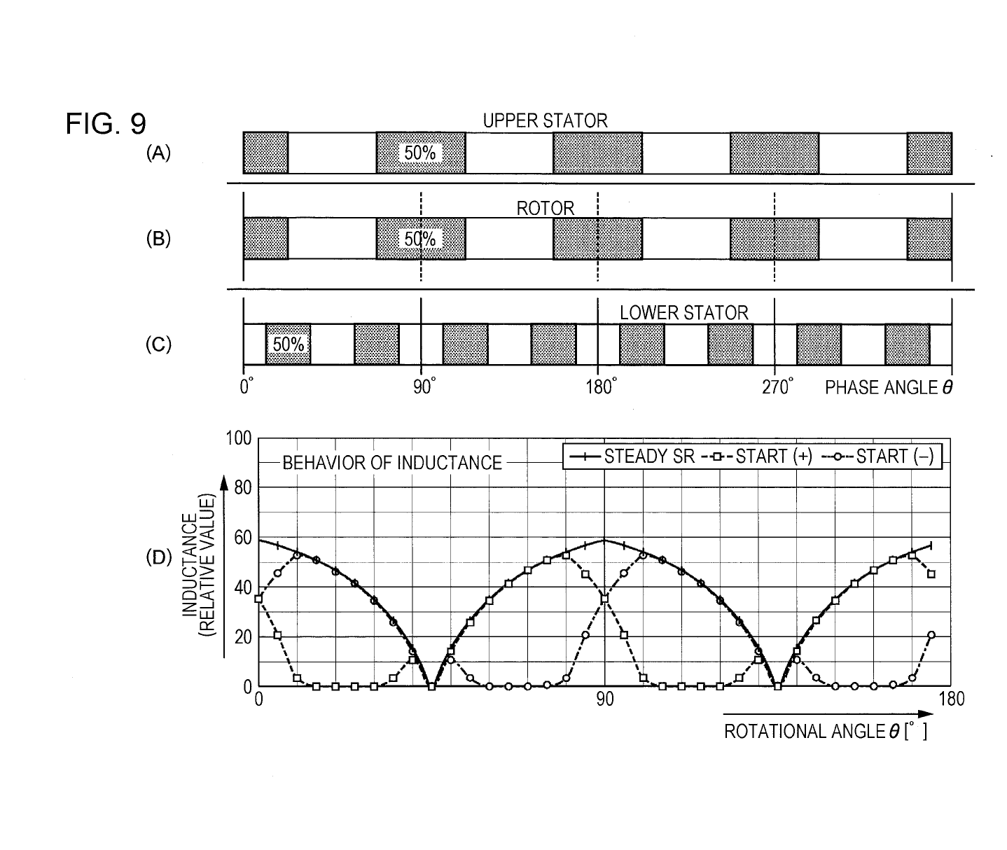

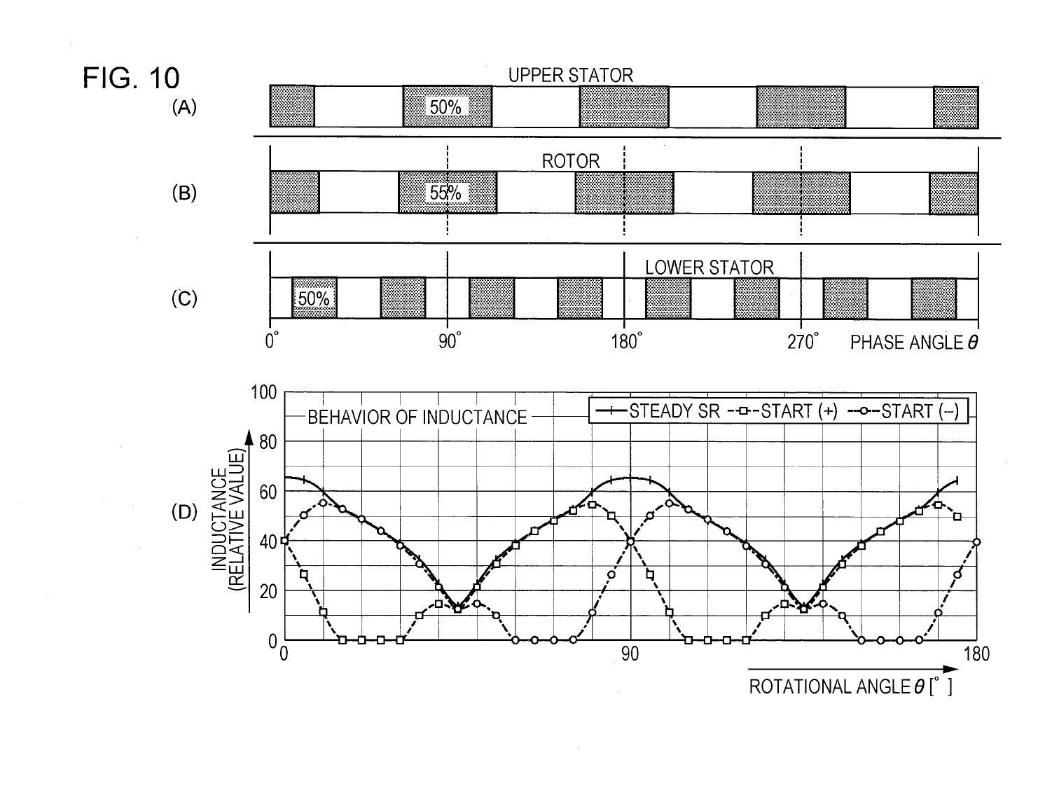

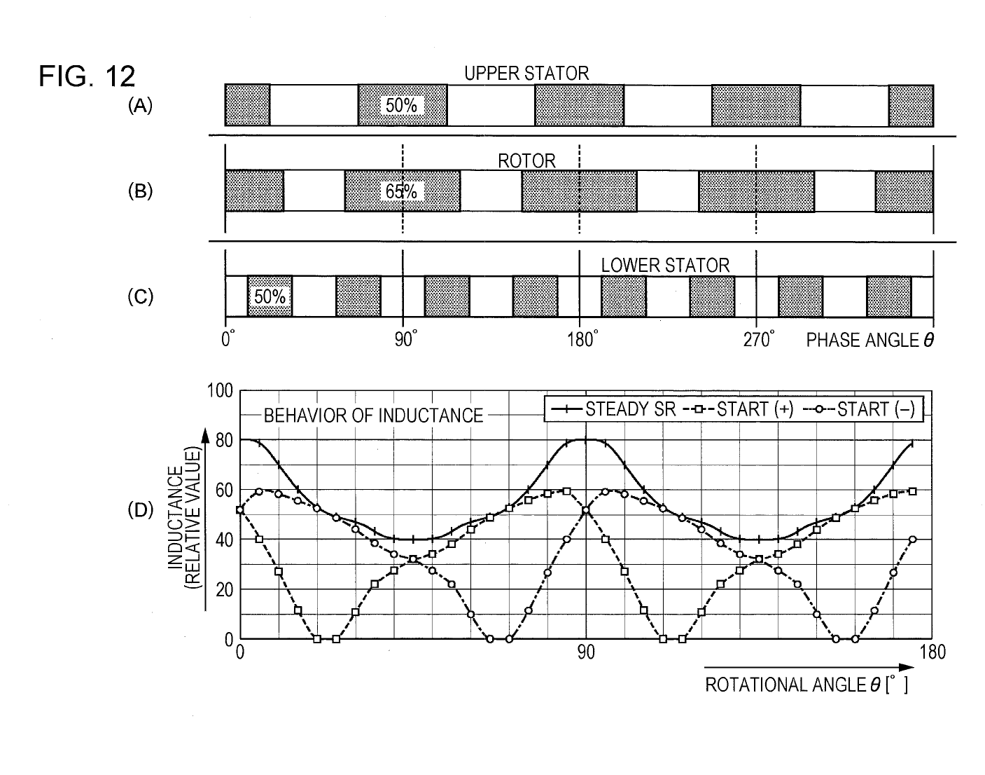

FIGS. 9 to 13 illustrates variation in inductance (relative value) with respect to the rotational angle of the rotor 4 in the case where both the starting coils 5 are turned off (that is, SR operation in steady state) and in the case where one of the starting coils 5 is turned on (bipolar state) when, in the peripheral direction of the rotor 4, the total (ratio) of the magnetic pole widths to the entire periphery is 50%, 55%, 60%, 65%, or 70%, respectively. In FIGS. 9 to 13, as described above, the rotor 4 has four poles, the first magnetic core 31 has four poles, and the second magnetic core 32 has eight poles; the total magnetic pole width is 50% of the entire periphery in the peripheral direction of the first magnetic core 31, and the total magnetic pole width is 50% of the entire periphery in the peripheral direction of the second magnetic core 32; and the magnetic poles of the second magnetic core 32 are shifted with respect to the first magnetic core 31 by 22.5°. In each of FIGS. 9 to 13, view (A) is a developed view of the entire periphery (360°) of the cylindrical plane defined by the above-described loci of the first magnetic core 31; View (B) is a developed view of the rotor 4; View (C) is a developed view of the second magnetic core 32; and View (D) illustrates variation in inductance with respect to the rotational angle of the rotor 4 over a range of 180°. In view (D), a solid line indicates the inductance in the steady state, a broken line indicates the inductance at the start of rotation in the forward direction, and a dotted chain line indicates the inductance at the start of rotation in the reverse direction. In FIGS. 3 and 4, in the peripheral directions of both the first and second magnetic cores 31 and 32, the total magnetic pole width is 50% of the entire periphery, and in this case, the central angles are 45° and 22.5°, respectively. In the peripheral direction of the rotor 4, the total magnetic pole width is 60% of the entire periphery and, in this case, the central angle is 54°.

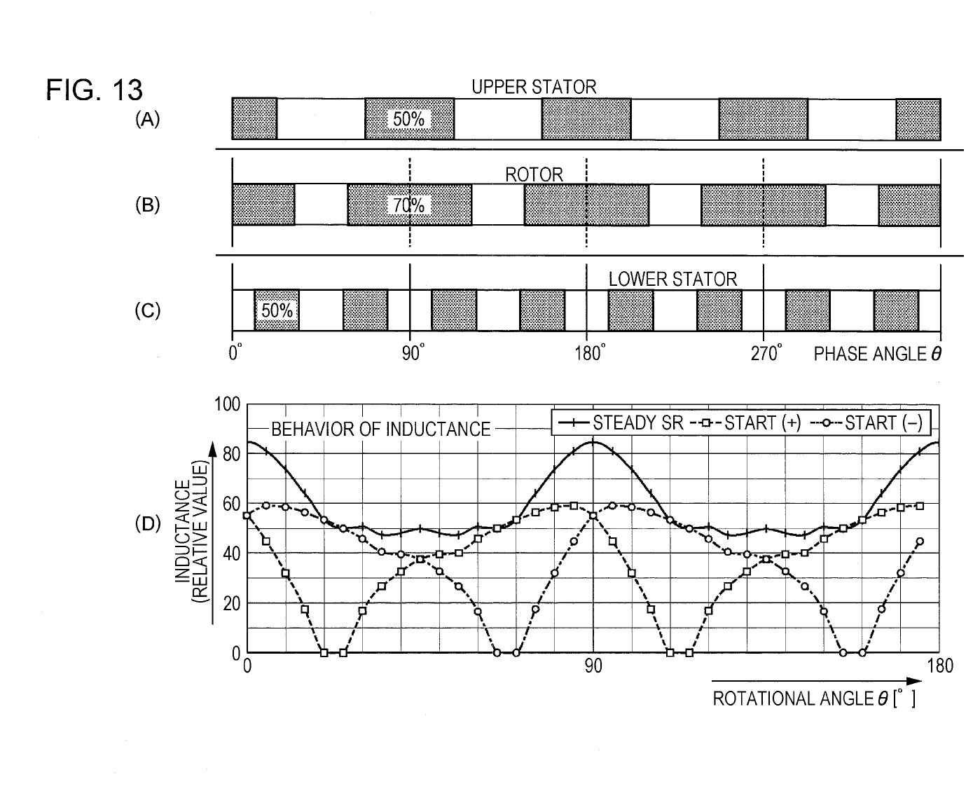

In order to obtain torque, a large variation in inductance is needed in a state in which both the starting coils 5 are turned off, and in order to start rotation in an intended direction at the start, the inductance in a state in which one of the starting coils 5 is turned on needs to have an increasing (decreasing) gradient (starting torque is generated) near extreme values of the inductance. When the width (ratio) of the magnetic poles of the rotor 4 is 50% as illustrated in FIG. 9, the inductance as described above is observed near the maximum value (at the rotational angles of 0°, 90°, and 180°). However, starting torque cannot be obtained near the minimum value (at the rotational angels of 45° and 135°). When the width (ratio) of the magnetic poles of the rotor 4 is 70% as illustrated in FIG. 13, although starting torque can be obtained near the minimum value, variation ΔL in inductance is decreased in a state in which both the starting coils 5 are turned off.

That is, inductance in SR drive has the maximum and minimum equilibrium points. The maximum and minimum equilibrium points respectively correspond to a “stable point” where the magnetic poles opposite one another and an “unstable point” where the magnetic poles are shifted from one another. In general, as long as a significantly extraordinary external force does not act on the brushless DC motor 1, the rotor does not settle at the latter point when the brushless DC motor 1 is stopped. Thus, even when the magnetic pole width of the rotor is 50%, there is no problem with starting the brushless DC motor 1. Examples of calculation with the width (ratio) of the magnetic poles of the rotor 4 being 55%, 60%, and 65% show that, even in the case where the load of the motor is special and there is a possibility of the rotor being stopped at the latter equilibrium point, by using the second magnetic core 32, the brushless DC motor 1 can be started in the forward or reverse direction as intended. However, when the magnetic pole width becomes excessively large, torque for SR drive is lost.

Thus, from the viewpoint of controllability of torque and starting rotation, in the cylindrical plane defined by the loci of the tips of the magnetic poles (protrusions 42) of the rotor 4, the ratio η of the length of the tips in the peripheral direction is preferably 50%≦η≦65% (that is, the ratio of the gaps between the protrusions 42 is from 50% to 35%). With such a structure, large torque is generated in the brushless DC motor 1 and starting of the brushless DC motor 1 from any stop position can be performed.

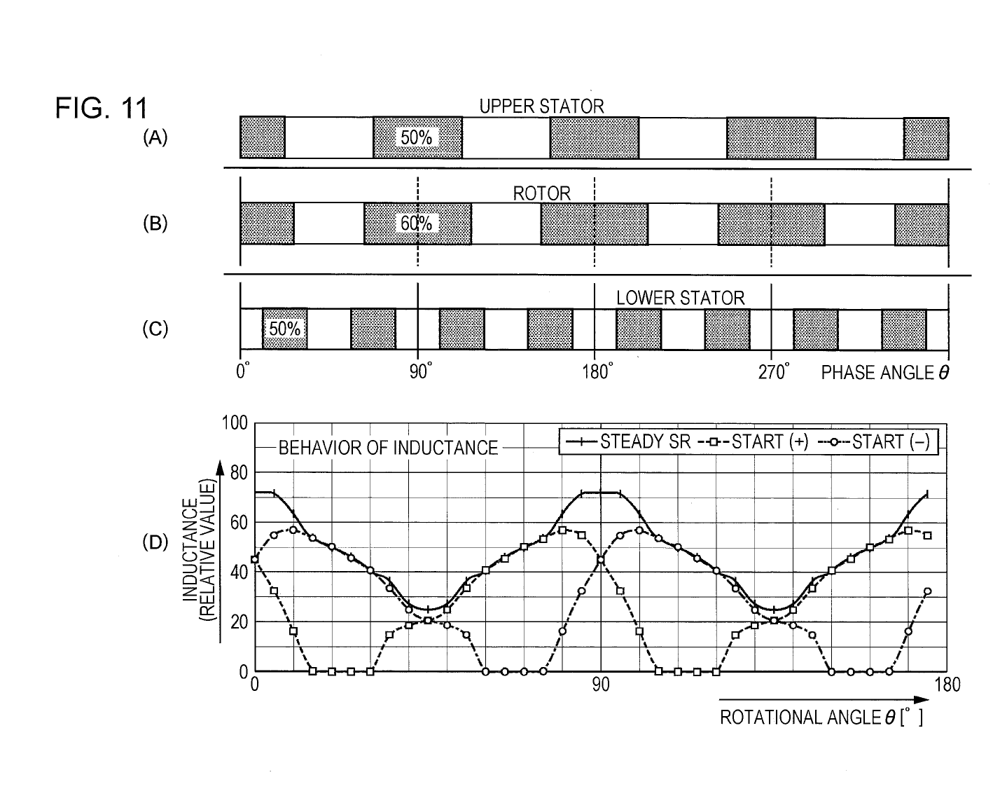

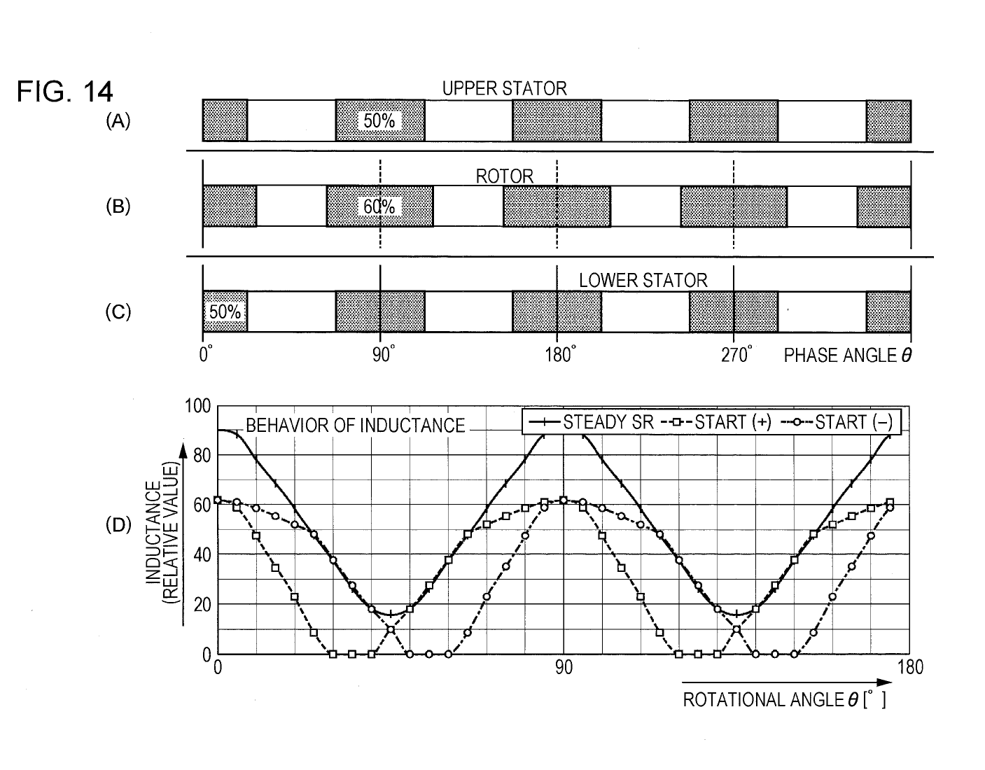

FIGS. 14 to 16 illustrate the results of variation in inductance due to rotation. The magnetic pole width of the rotor 4 is fixed to 60% similarly to the case illustrated in FIG. 11. The magnetic poles of the second magnetic core 32 of the stator 3 are shifted by the angles of ±11.25° (magnetic pole width is 50%; 22.5° as the central angle, contacted), ±16.9° and 25° (larger than equal space) with respect to the magnetic poles of the first magnetic core 31. In these drawings, similarly to FIGS. 9 to 13, view (A) is a developed view of the entire periphery (360°) of the cylindrical plane defined by the loci of the first magnetic core 31; view (B) is a developed view of the rotor 4; view (C) is a developed view of the second magnetic core 32; and view (D) illustrates variation in inductance with respect to the rotational angle of the rotor 4 over a range of 180°.

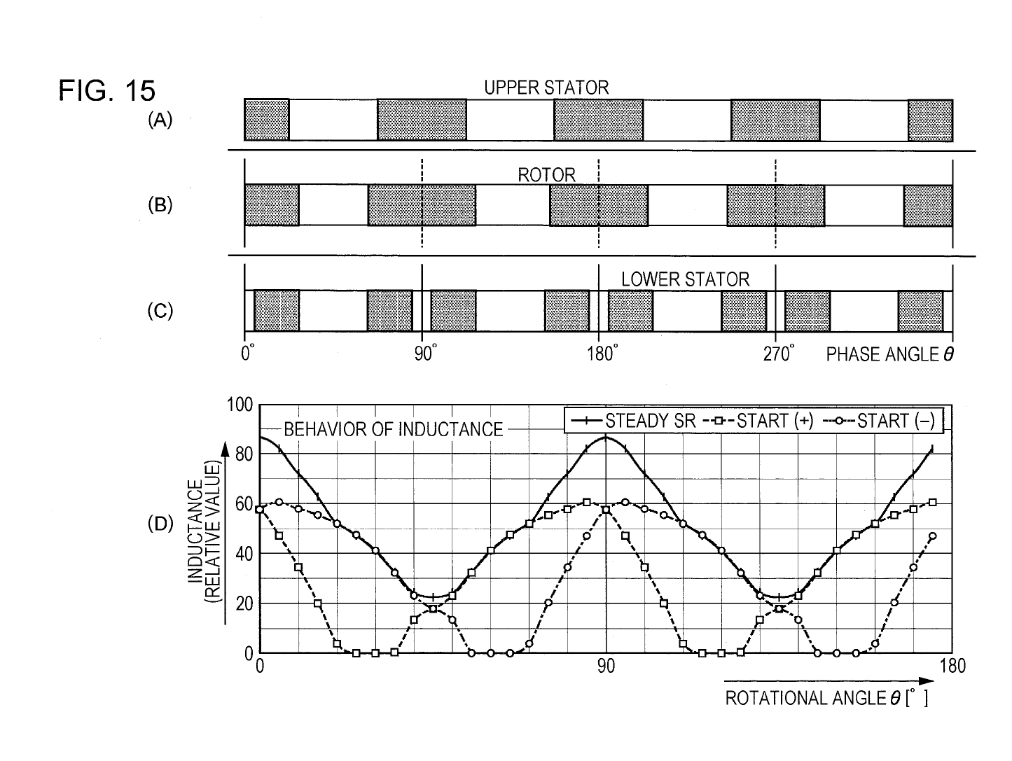

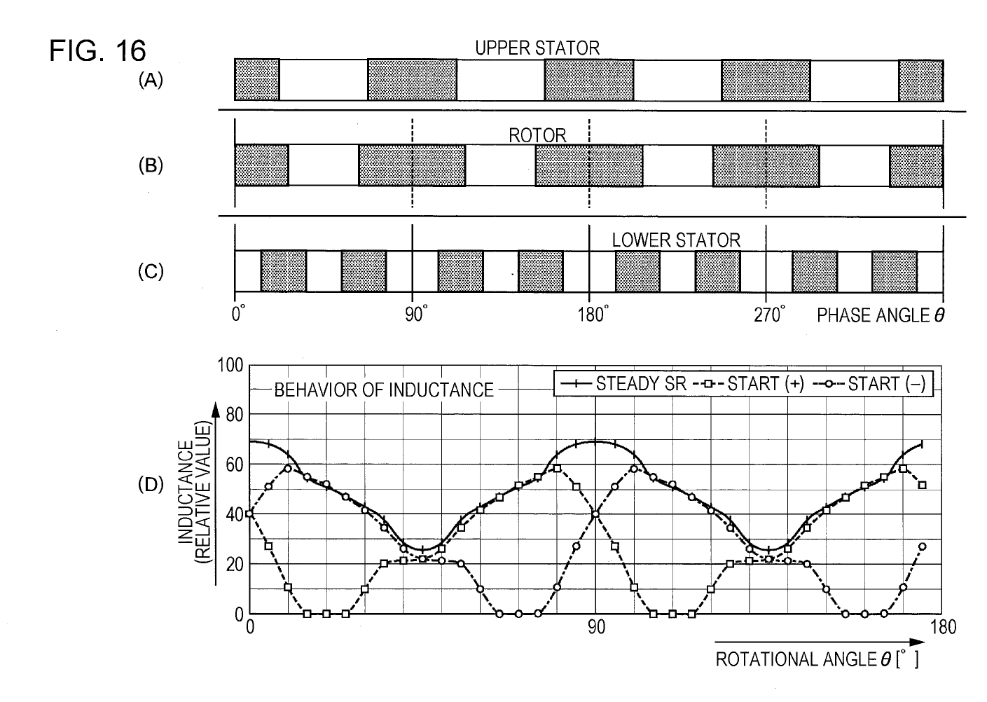

As a result, in the case illustrated in FIG. 14, in which the protrusions 321 of the second magnetic core 32 in a pair are in contact with each other, variation in inductance is large when both the starting coils 5 are turned off. However, when the protrusions 42 of the rotor 4 are stopped near the middle of the pairs of the protrusions 321 of the second magnetic core 32, in which direction the brushless DC motor 1 is started to rotate is uncertain. Furthermore, in the case illustrated in FIG. 15, in which the shift is ±16.9°, compared to the case illustrated in FIG. 11, in which the shift is ±22.5°, an increasing (decreasing) gradient of the inductance is not significant when the one of the starting coils 5 is turned on. In the case illustrated in FIG. 16, in which the shift is ±25°, compared to the case illustrated in FIG. 11, in which the shift is ±22.5°, the width where starting torque is not generated is large when the one of the starting coils 5 is turned on. Thus, among the conditions illustrated in FIGS. 14 to 16, the conditions being conditions under which the second magnetic core 32 is shifted, there is no conditions under which a behavior of the inductance becomes more desirable than that illustrated in FIG. 11, and accordingly, the optimum condition is the shift of ±22.5°.

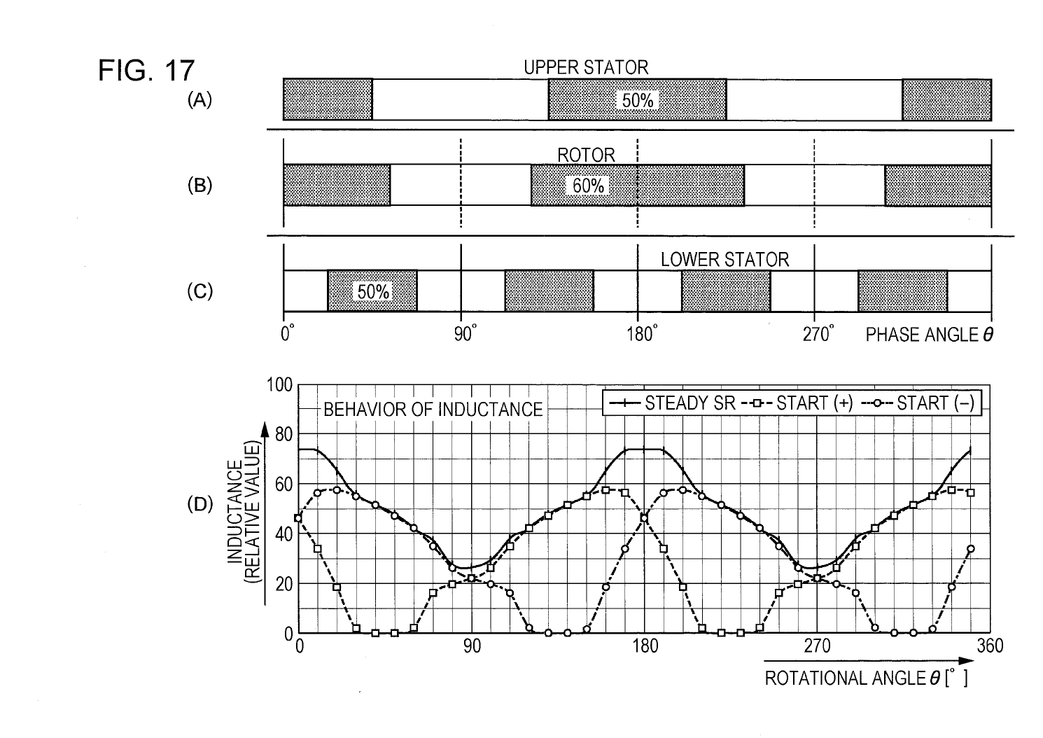

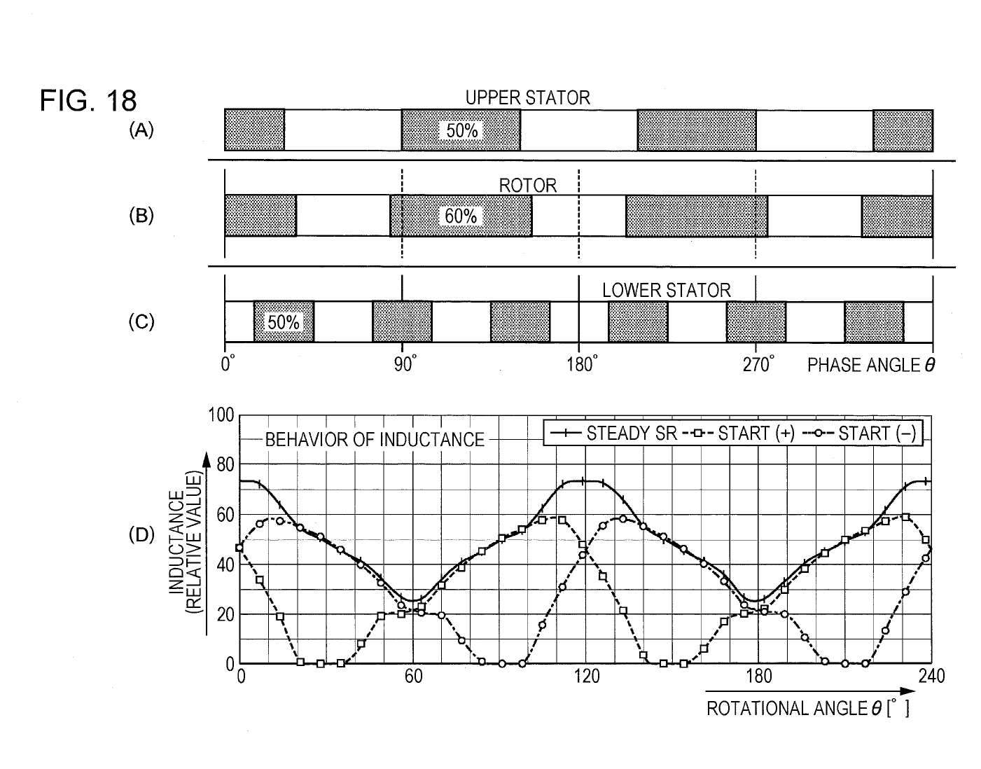

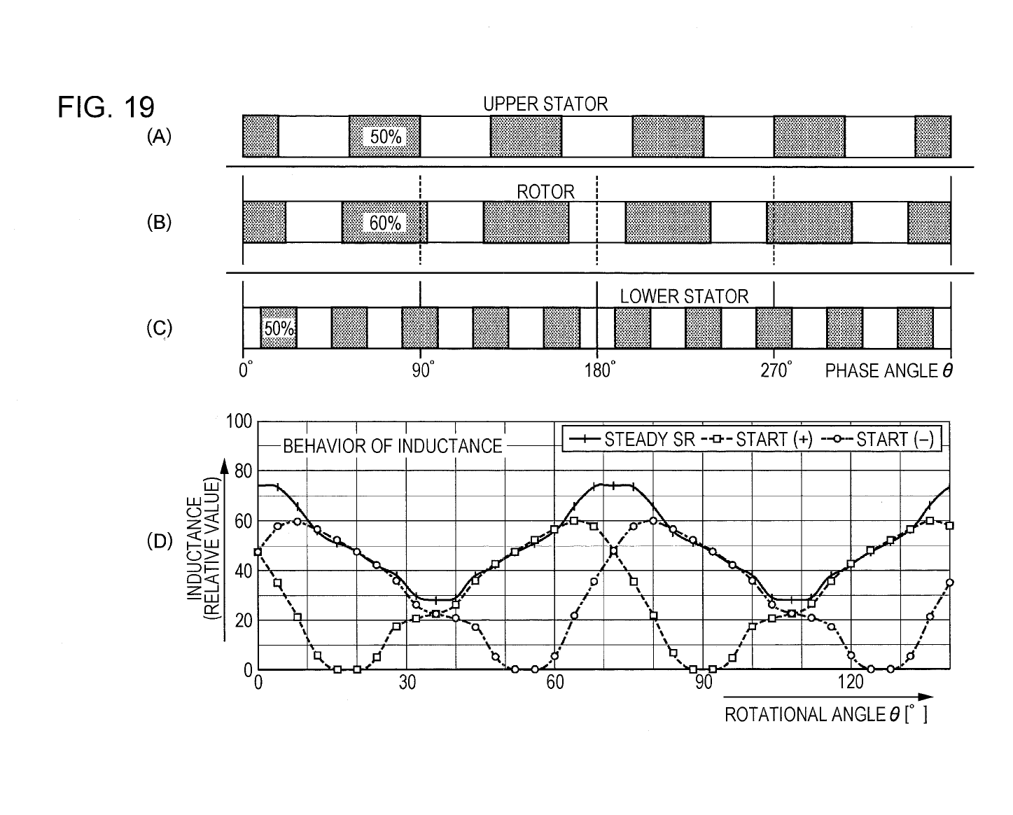

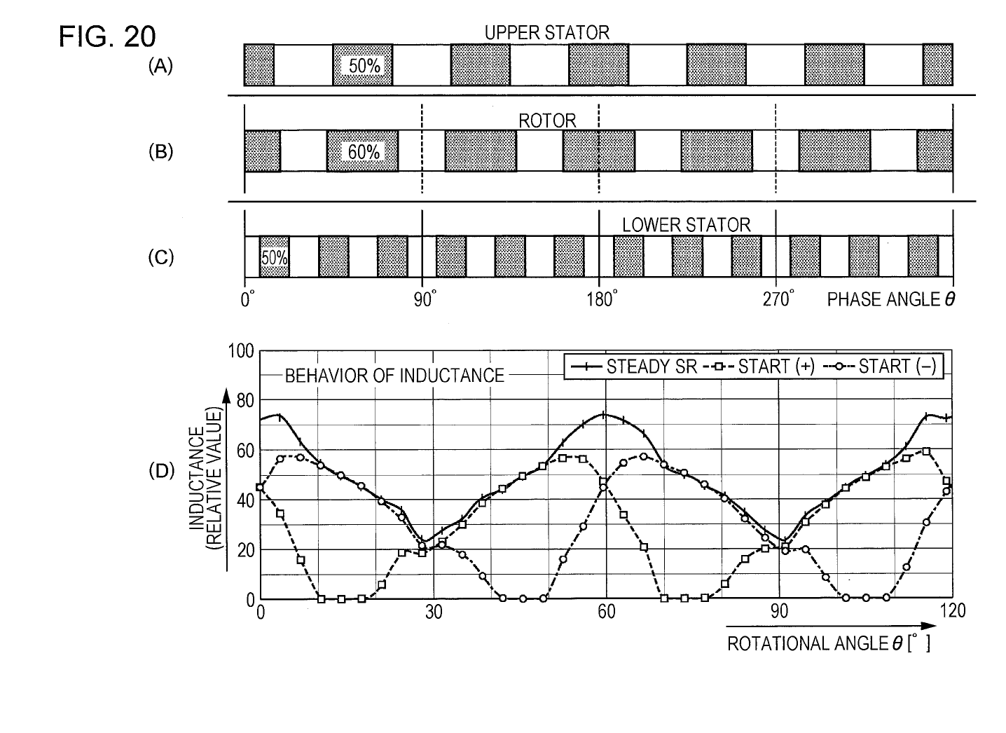

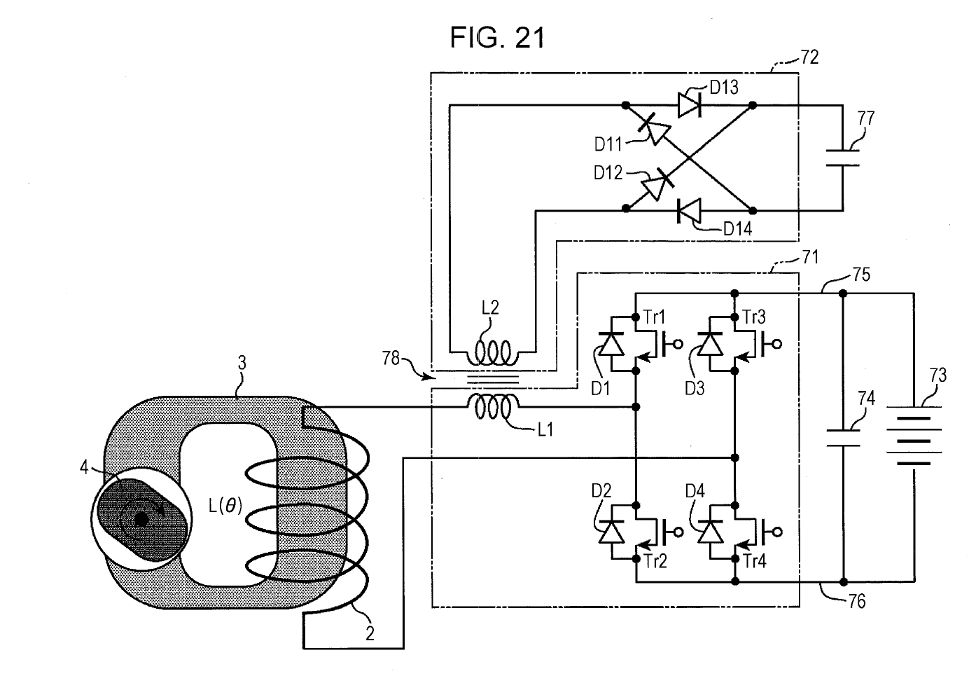

FIGS. 17 to 20 illustrates the behavior of inductance in the case where the numbers of the magnetic poles of the first magnetic core 31, the rotor 4, and the second magnetic core 32 are changed while the above-described relationships of the numbers of the magnetic poles, 1:1:2, are maintained. As described above, the numbers of the magnetic poles of the first magnetic core 31, the rotor 4, and the second magnetic core 32 are respectively 2, 2, and 4 in FIGS. 17, 3, 3, and 6 in FIGS. 18, 5, 5, and 10 in FIGS. 19, and 6, 6, and 12 in FIG. 20. As is the case with FIG. 11, the total magnetic pole widths in the peripheral direction of the first magnetic core 31, the rotor 4, and the second magnetic core 32 are respectively 50%, 60%, and 50% of the corresponding entire peripheries. In these drawings, similarly to FIGS. 9 to 13, view (A) is a developed view of the entire periphery (360°) of the cylindrical plane defined by the loci of the first magnetic core 31; view (B) is a developed view of the rotor 4; view (C) is a developed view of the second magnetic core 32; and view (D) illustrates variation in inductance with respect to the rotational angle of the rotor 4.

There is no significant difference among the results illustrated in FIGS. 17 to 20 because the structures illustrated in FIGS. 17 to 20 are geometrically equal to one another. In this analysis of the approximation model (approximation in which lines of magnetic induction pass through only the area where the magnetic poles are superposed), torque is proportional to the number of the poles. However, since a magnetic flux actually leaks to the magnetic poles and recessed areas in the magnetic poles, it is assumed that a certain number of poles are optimum for torque. Despite this, there is no general rule because of dependence on recessed shapes and dimensions.

FIG. 21 is a block diagram illustrating examples of structures of a drive circuit 71 and a regenerative circuit 72 of the brushless DC motor 1 having the above-described structure. The drive circuit 71 includes a reactor L1 and a bridge circuit that includes switching elements Tr1 to Tr4 and anti-parallel diodes D1 to D4 serving as surge absorbers for the switching elements Tr1 to Tr4. The drive circuit outputs drive pulses and start pulses, which will be described later, to the exciting coil 2. The drive circuit 71 uses as its power circuit secondary batteries 73 and a capacitor 74 for stabilization, which is connected in parallel with the secondary batteries 73. The drive circuit 71 is controlled by a drive control circuit (not shown). A series circuit of the switching elements Tr1 and Tr2 and a series circuit of the switching elements Tr3 and Tr4 (these two series circuits are connected in parallel with each other) are connected between power lines 75 and 76 from the secondary batteries 73 and the capacitor 74. Nodes where the switching elements Tr1 and TR2, and TR3 and Tr4 are connected to each other serve as output terminals through which the exciting coil 2 obtains output. The reactor L1 is connected between one of the output terminals and the exciting coil 2.

When the switching elements Tr1 and Tr4 of the drive circuit 71 are turned on by the drive control circuit (not shown), the rotor 4 can be rotated in one direction, and when the switching elements Tr3 and Tr2 of the drive circuit 71 are turned on by the drive control circuit (not shown), the rotor 4 can be rotated in the other direction. By controlling duties of the switching elements Tr1 to Tr4, the wave height value of the drive pulses provided to the exciting coil 2 is adjusted, thereby the wave height value of the exciting current is adjusted. Furthermore, by turning on the switching elements Tr2 and Tr4 by the drive control circuit (not shown), both terminals of the exciting coil 2 can be grounded. In order to control such switching elements Tr1 to Tr4, an encoder (not shown) is provided in the rotor 4 of the brushless DC motor 1. The drive control circuit controls the switching elements Tr1 to Tr4 as will be described later in accordance with the rotational angle position detected by the encoder. The switching elements Tr1 to Tr4 include power transistors such as IGBTs or MOS-FETs. A capacitor may be connected in parallel with the reactor L1. When regeneration is not performed, the reactor L1 may be included in the inductance L on the brushless DC motor 1 side.

The regenerative circuit 72 includes a reactor L2 and a full-wave rectifier circuit that includes diodes D11 to D14. The regenerative circuit 72 outputs regenerated power to a capacitor 77. The reactor L2 together with the reactor L1 on the drive circuit 71 side forms a current transformer 78. When the rotor 4 is rotated by an external force, or when the rotor 4 is decelerated for, for example, stopping, by supplying an exciting current from the drive circuit 71 to the exciting coil 2, a magnetic field is generated in the reactor L1. In this state, when the inductance changes due to rotation of the rotor 4, a counterelectromotive force is generated in the reactor L1, thereby storing a regenerated current in the capacitor through the reactor L2. This is a general mechanism of regeneration. More specifically, the exciting current is switched by the switching elements Tr1 to Tr4, and by adjusting timing of the switching, the exciting coil 2 and the reactor L1 enter a resonant state. The resonance current is taken by the reactor L2 and rectified by the diode bridge, thereby obtaining a regenerative voltage.

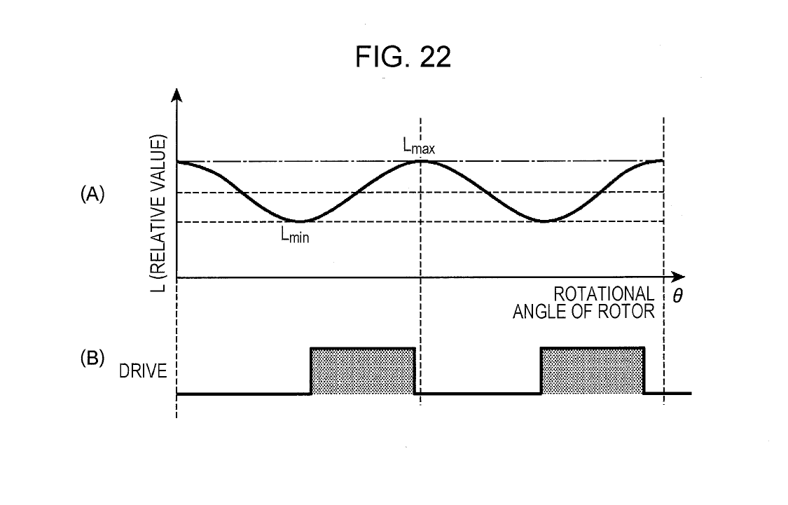

FIG. 22 illustrates a state of drive in the steady rotation state using the drive control circuit. In FIG. 22, view (B) illustrates drive pulses provided from the drive control circuit to the switching elements Tr1 and Tr4; Tr3 and Tr2 during acceleration. View (A) of FIG. 22 illustrates variation in the inductance L in such driving. When accelerating, the drive pulse is turned on near a point where the inductance L becomes the minimum Lmin, and the drive pulse is turned off near a point where the inductance L becomes the maximum Lmax.

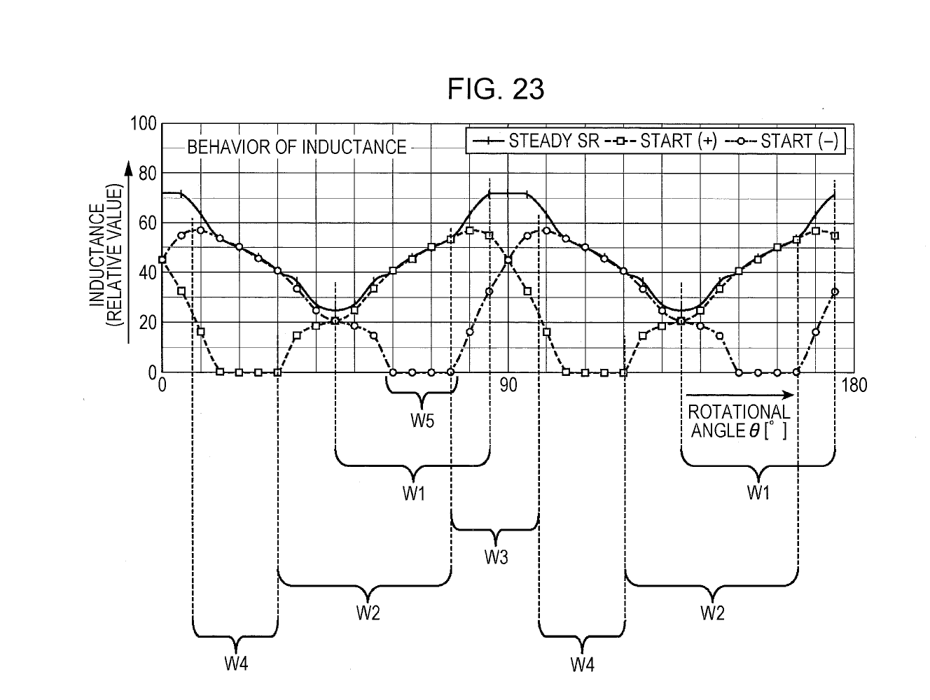

A method for starting according to the present embodiment using the above-described drive circuit 71 is described with reference to FIG. 23. FIG. 23 illustrates variation in inductance similarly to the aforementioned view (D) of FIG. 11. That is, the first magnetic core 31 and the rotor 4 each have four poles; the second magnetic core 32 has eight poles; the magnetic pole width of the first magnetic core 31 is 50%; the magnetic pole width of the rotor 4 is 60%; the total magnetic pole width of the second magnetic core 32 is 50%; and the magnetic poles of the second magnetic core 32 are shifted with respect to the first magnetic core 31 by 22.5°.

As described above, the rotational angle position of the rotor 4 is detected by the encoder or the like. The drive control circuit controls the current in start pulses and drive pulses in response to detection results of a rotation start angle as illustrated in Table 2 in accordance with four types of angular regions W1 to W4 below. In FIG. 23, the motor is assumed to be driven in the forward rotational direction (left to right in a graph). When the motor is driven in the reverse rotational direction, assignment of the angular regions W1 to W4 is inverted.

In Table 2, starting points from the angular regions, which have inductance characteristics as illustrated in FIG. 23, are focused and waveforms from the start through acceleration to steady rotation are illustrated. In Table 2, by combining together waveforms represented by periods T0, T1, T2, and T3 and waveforms drawn by inverting the polarities of the waveforms represented by T1 to T4, torque control and speed control for every operational pattern can be realized. It is noted that, even when the same start pulses or the drive pulses are input, an actual response to the input differs depending on, for example, the weight of a load or the position where rotation is started in the angular regions W1 to W4. Accordingly, examples shown, in Table 2 serve only as guides. The drive control circuit sequentially controls the number of the start pulses and the wave height value of the drive pulses in response to detection results of the encoder. In Table 2, ∫Lp/∫θ and ∫Lm/∫θ indicate variations in inductance of a pair of the protrusions 321 of the second magnetic core 32 when the brushless DC motor 1 is started. ∫Lp/∫θ indicates the magnetic core on the upstream side (START (+) in FIG. 23) with respect to the rotational direction. ∫Lm/∫θ indicates the magnetic core on the downstream side (START (−) in FIG. 23) with respect to the rotational direction.

Initially, in the angular region W2 where the magnetic poles of the rotor 4 are comparatively far from the magnetic poles of the first magnetic core 31, the inductance increases (positive) in the magnetic core on the upstream side with respect to the rotational direction, and the inductance decreases (negative) in the magnetic core on the downstream side with respect to the rotational direction. Thus, by providing the start pulses and drive pulses shown in the type 3 in Table 2 from the drive circuit 71 to the exciting coil 2, the brushless DC motor 1 is started to rotate. That is, by outputting the start pulses illustrated in the period T1, out of a pair of the starting coils 5, the starting coil 5 on the upstream side with respect to the rotational direction is turned off and the starting coil 5 on the downstream side with respect to the rotational direction is turned on. Thus, the rotor 4 is attracted by the magnetic pole of the second magnetic core 32 on the upstream side, and accordingly, the brushless DC motor 1 is started to rotate in the forward direction. After that, as illustrated in the period T2, drive pulses having a large wave height value are output so as to accelerate the brushless DC motor 1 until the rotation speed reaches a certain speed. When the certain speed is reached, rotation of the brushless DC motor 1 is changed to steady rotation, and as illustrated in the period T3, the wave height value of the drive pulses is decreased and the steady rotation of the brushless DC motor 1 is maintained. In the angular region W2, particularly in the angular region W5 where the inductance of the magnetic pole on the downstream side with respect to the rotational direction is almost zero, as illustrated in the type 4 in Table 2, the number of the start pulses in the period T1 can be decreased.

In contrast, in the angular region W3 where the magnetic poles of the rotor 4 are comparatively close to the magnetic poles of the first magnetic core 31, the inductance decreases (negative) in the magnetic core on the upstream side with respect to the rotational direction, and the inductance increases (positive) in the magnetic core on the downstream side with respect to the rotational direction. Thus, by providing the start pulses and drive pulses shown in the type 2 in Table 2 from the drive circuit 71 to the exciting coil 2, the brushless DC motor 1 is started to rotate. That is, by outputting the start pulses having an inverted polarity illustrated in the period T1′, out of a pair of the starting coils 5, the starting coil 5 on the downstream side with respect to the rotational direction is turned off and the starting coil 5 on the upstream side with respect to the rotational direction is turned on. Thus, the rotor 4 is attracted by the magnetic pole of the second magnetic core 32 on the downstream side, and accordingly, the brushless DC motor 1 is started to rotate in the forward rotational direction. After that, as illustrated in the periods T2 to T3, the wave height value of the drive pulses having a positive polarity is controlled, the exciting current is controlled to change from large to small, rotation of the brushless DC motor 1 is changed into the steady rotation, and this state is maintained.

In contrast, in the case where the brushless DC motor 1 is started from the angular region W4 where the magnetic poles of the rotor 4 has passed the magnetic poles of the first magnetic core 31, the inductance is almost zero in the magnetic core on the upstream side with respect to the rotational direction, and the inductance decreases (negative) in the magnetic core on the downstream side with respect to the rotational direction. Thus, by providing the inverted pulses, start pulses and drive pulses shown in the type 1 in Table 2 from the drive circuit 71 to the exciting coil 2, the brushless DC motor 1 is started to rotate. That is, in the period T0, out of a pair of the starting coils 5, the starting coil 5 on the upstream side with respect to the rotational direction is turned off and the starting coil 5 on the downstream side with respect to the rotational direction is turned on. Thus, the rotor 4 is attracted by the magnetic pole of the second magnetic core 32 on the upstream side, and accordingly, the brushless DC motor 1 is started to rotate in the reverse rotational direction and positioning is performed. In the period T1′, out of a pair of the starting coils 5, the starting coil 5 on the downstream side with respect to the rotational direction is turned off and the starting coil 5 on the upstream side with respect to the rotational direction is turned on. Thus, the rotor 4 is attracted by the magnetic pole of the second magnetic core 32 on the downstream side, and accordingly, the brushless DC motor 1 is started to rotate in the forward rotational direction. After that, in the periods T2 and T3, the exciting current is similarly controlled.

In order to rotate in the reverse rotational direction, in the angular regions W1 to W5, control with currents whose polarities of the current waveforms in Table 2 are inverted can be performed. Furthermore, on the basis of the above-described operations, a variety of needs can be satisfied by the following application current control sequences. For example, in order to improve power efficiency as much as possible even when the brushless DC motor 1 is started to rotate, when rotation is started while the angular region of the rotor 4 is the angular region W1 in FIG. 23, the drive circuit 71 causes an acceleration current for the period T2 to directly flow through the exciting coil 2, thereby allowing the brushless DC motor 1 to be started to rotate. In another case, it may be desirable that a time period, during which motor torque for load torque is generated, be increased as much as possible during rotation without consideration for power efficiency. In order to do this, in the angular region W2 in FIG. 23, a pulse current, which causes the rectifier cells 52 of the starting coils 5 to be turned on as illustrated in the period T1 in the type 3 in Table 2, is caused to flow through the exciting coil 2, and in the angular region W3, a pulse current, which causes the rectifier cells 52 of the starting coils 5 to be turned on as illustrated in the period T1′ in the type 1 in Table 2, is caused to flow through the exciting coil 2. This can increase the time period during which torque of the brushless DC motor 1 is generated.

As described above, with a method for controlling the brushless DC motor 1 according to the present embodiment, as illustrated in the periods T1 and T1′ in Table 2, by providing a start-up time and a wave height sufficient to cause the rectifier cells 52a and 52b of the starting coils 5a and 5b to be turned on and by providing a pulse current having a polarity corresponding to an intended rotational direction to the exciting coil 2, the rotor 4 is started to rotate in the intended rotational direction. Thus, even when the protrusions 42 of the rotor 4 are stopped at middle positions between the protrusions 321 of the second magnetic core 32 as mentioned before, the brushless DC motor 1 can be reliably started.

In the method for controlling the brushless DC motor 1 according to the present embodiment, in order to rotate the brushless DC motor 1 from a position where an inductance characteristic generated between the stator 3 and the rotor 4 does not increase due to the rotational angle position of the rotor 4 with respect to the intended rotational direction of the rotor 4, a current is caused to flow through the exciting coil 2 in advance as illustrated in the period T0 in Table 2, the current being a current for rotating the rotor 4 in the reverse rotational direction to an angle where the inductance increases so that the rotor 4 rotates in the intended rotational direction, and after the angle where the inductance increases so that the rotor 4 rotates in the intended rotational direction has been reached, a pulse current illustrated in the periods T1 and T1′ is provided. Thus, even in the case where the stop position of the rotor 4 is a position where starting torque in the intended rotational direction cannot be obtained, the brushless DC motor 1 can be reliably started in an original intended rotational direction.

After the rotor 4 has been started to rotate, only in the angular region W1 where the inductance increases so that the rotor 4 rotates in the intended rotational direction, by causing a current of the same sign as the rotational direction (a positive current for the forward rotational direction and a negative current for the reverse rotational direction) to flow through the exciting coil 2 and by controlling the wave height value of the current by duty control with the switching elements Tr1 to Tr4, the rotational speed of the rotor 4 in the intended rotational direction can be maintained, or the rotational speed can be controlled to any rotational speed.

A start-up time and a wave height sufficient to cause the rectifier cells 52a and 52b of the starting coils 5a and 5b to be turned on are provided and a current having a polarity corresponding to an intended rotational direction is caused to flow through the exciting coil 2. Thus, in the brushless DC motor 1 according to the present embodiment, torque control corresponding to load torque and high-speed rotation control at a speed exceeding a rated number of rotations with small load torque can be performed.

Preferably, a plurality of the stators 3 are stacked one on top of another in the rotational axis Z direction. This can improve torque as many times as the number of the plurality of stators 3 in the brushless DC motor 1 according to the present embodiment. By equally shifting phase angles of the first and second magnetic cores 31 and 32 in the plurality of stators 3, cogging torque can be decreased in the brushless DC motor 1 according to the present embodiment.

Out of a variety of forms of technologies disclosed in the present description as described above, the main technologies are summarized as follows.

A brushless DC motor according to a form of implementation includes a stator that includes a single exciting coil, a rotor provided coaxially with the stator inside the stator. In the brushless DC motor, variation in magnetic resistance between the stator and the rotor with respect to a flow of a magnetic flux generated around the exciting coil is used as a driving force. In the brushless DC motor, the rotor has a base portion and a plurality of protrusions that serve as magnetic poles and radially extend outward from the base portion so as to be equally spaced apart from one another in a peripheral direction. In the brushless DC motor, the stator includes the annular exciting coil, annular main bodies disposed on one and the other side of the exciting coil in a rotational axis direction, and first and second magnetic cores each having a plurality of protrusions that serve as magnetic poles and radially extend inward from the main body so as to be arranged in the peripheral direction. In the brushless DC motor, the numbers of protrusions of the first and second magnetic cores are different from each other.

The brushless DC motor having such a structure is an SR motor that includes a stator that includes an exciting coil and a rotor provided coaxially with the stator inside the stator, for example, an inner rotor, and that uses as a driving force variation in magnetic resistance between the stator and the rotor with respect to a flow of a magnetic flux generated around the exciting coil.

In order to use a single exciting coil, the following structure is adopted. That is, in the brushless DC motor having the above-described structure, both the stator and the rotor have salient poles (magnetic poles). As is the case with a usual rotor, the rotor has the base portion and the plurality of protrusions, which serve as the magnetic poles, and radially extend outward from the base portion so as to be equally spaced apart in the peripheral direction. In the stator, the numbers of protrusions serving as magnetic poles of the first and second magnetic cores, which are disposed on one and the other side of the annular exciting coil in the rotational axis direction, are different from each other.

In the case of a usual SR motor, claw-poles that extend in the axial direction are regularly alternatingly arranged so as to be side by side with one another in the two magnetic cores disposed on both the sides of the thus structured exciting coil in the rotational axis direction, and the magnetic flux flows in the diametrical direction through the rotor. In the brushless DC motor having such a structure, the protrusions, which serve as magnetic poles, are salient poles that radially extend inward from the annular main bodies. Thus, the magnetic flux flows from the protrusion of the first magnetic core (second magnetic core) into the rotor through to the protrusion of the second magnetic core (first magnetic core) from the side of the rotor into which the magnetic flux has flowed. Since the numbers of protrusions of the first and second magnetic cores are different from each other, rotational torque is generated in the peripheral direction at a position or positions between the magnetic poles, thereby allowing the brushless DC motor having such a structure to be driven with the single exciting coil. Thus, the brushless DC motor having such a structure has a three-dimensional magnetic circuit provided with an electromagnetic coil and a single stator having salient poles and allows magnetic force to be more effectively utilized.

In another form of implementation, in the above-described brushless DC motor, the number of the protrusions of the first magnetic core is the same as the number of the protrusions of the rotor, the number of the protrusions of the second magnetic core is twice the number of the protrusions of the rotor, an induction coil that includes a loop-shaped conducting member and a rectifier cell arranged in the conducting member is provided around each of the protrusions of the second magnetic core, and the rectifier cells are arranged so that the rectifier cells of the adjacent magnetic poles limit flows of current in directions opposite to each other.

In the brushless DC motor having such a structure, by setting the number of the protrusions of the first magnetic core to be the same as the number of the protrusions of the rotor, comparatively uniform rotational torque can be generated. By forming the second magnetic core as described above, directions of voltages in the adjacent induction coils, the voltages being voltages induced in the induction coils by start pulses provided to the exciting coil, are opposite to each other. In one of the adjacent induction coils, the rectifier cell is turned on so as to allow a loop current to flow through the induction coil, thereby canceling out the exciting magnetic flux (counter magnetic flux), and in the other induction coil, the rectifier cell is turned off so as to prevent a loop current from flowing therethrough, and accordingly, the exciting magnetic flux is not canceled out. Thus, in the brushless DC motor having such a structure, even when the rotor is stopped between the protrusions of the second magnetic core, unbalanced magnetic field is generated in the adjacent protrusions of the second magnetic core. This can prevent variation in the magnetic resistance from becoming uniform. Thus, with the above-described structure, even with a combination of a single exciting coil and the stator, an SR motor that can perform self-starting is realized.

In another form of implementation, in the above-described brushless DC motor, the protrusions of the second magnetic core are arranged such that, in a pair of the protrusions, one and the other protrusions are equally shifted in the peripheral direction from a corresponding one of the protrusions of the first magnetic core disposed at the center of the one and the other protrusions.

In the brushless DC motor having such a structure, by disposing protrusions of the second magnetic core with respect to the protrusions of the first magnetic core as described above, more uniform rotational torque can be generated.

In another form of implementation, in these above-described brushless DC motors, in a cylindrical plane defined by loci of tips of protrusions of the rotor, the length (=area) of the tips in the peripheral direction is from 50 to 65% (that is, the gap between the protrusions is from 50 to 35%).

In the brushless DC motor having such a structure, by forming protrusions of the rotor as described above, large torque can be generated.

In another form of implementation, in these above-described brushless DC motors, the exciting coil is formed by winding a band-like conducting member such that a width direction of the band-like conducting member extends in the rotational axis direction of the exciting coil.

In the brushless DC motor having such a structure, by forming the exciting coil as above, eddy currents generated in the exciting coil can be suppressed, and accordingly, generation of heat can be suppressed. Furthermore, since the band-like conducting member can be wound without gaps, in the brushless DC motor having such a structure, compared to the case where a cylindrical element wire is wound, current density can be increased and heat dissipation from the inside of the conducting member is desirable.

In another form of implementation, in these above-described brushless DC motors, the conducting members of the induction coils are integrated together into a cage-shaped structure that includes support columns that extend in the rotational axis direction and are disposed on one and the other sides of the protrusions of the second magnetic core and two annular members disposed on upper and lower sides of the protrusions and connected to both ends of each support column, and the rectifier cells are disposed in one of the annular members arranged between the first and second magnetic cores and the annular members surround around each magnetic pole.

In the brushless DC motor having such a structure, since the induction coils are integrated into the cage-shaped structure, the induction coils can be wound around the second magnetic core only by joining the one of the annular members to the support columns after the induction coils have been fitted onto one the second magnetic core with one of the annular members removed. This facilitates the assembly of the brushless DC motor.

In another form of implementation, in these above-described brushless DC motors, the first and second magnetic cores and the rotor are each formed of one of a dust core formed of an iron-based soft magnetic powder, a ferrite magnetic core, and a magnetic core formed of a soft magnetic material formed by dispersing a soft magnetic alloy powder in a resin.

In such a brushless DC motor, since the first and second magnetic cores and the rotor are each formed of one of the above-described cores, the first and the second magnetic cores and the rotor can be molded into optimum and complex shapes.

In another form of implementation, in these above-described brushless DC motors, a plurality of the stators are stacked one on top of another in the rotational axis direction.

With such a brushless DC motor, torque can be increased as many times as the number of the plurality of stators. Also in such a brushless DC motor, by shifting phase angles of the first and second magnetic cores from each other by the same amount in the plurality of stators, nearly uniform rotational torque can be obtained.

In another form of implementation, in these above-described brushless DC motors, the main body of at least one of the first and second magnetic cores has an L-shaped section in the peripheral direction.

The assembly of the brushless DC motor having such a structure can be performed only by fitting the exciting coil into the L-shaped structure.

A method for controlling a brushless DC motor according to another form of implementation is a method for controlling any one of these above-described brushless DC motors. The method includes starting the rotor in an intended rotational direction by providing the exciting coil with a pulse current that has a start-up time and a wave height that are sufficient to cause the rectifier cells of the induction coils to be turned on and that has a polarity corresponding to the intended rotational direction.

Thus, using the method for controlling the brushless DC motor having such a structure, even when the protrusions of the rotor are stopped at positions between the protrusions of the second magnetic core as mentioned before, the brushless DC motor can be reliably started.

In another form of implementation, in the above-described method for controlling brushless DC motor, when the brushless DC motor is rotated from a position where an inductance characteristic generated between the stator and the rotor does not increase due to the rotational angle position of the rotor with respect to the intended rotational direction of the rotor, a current is caused to flow through the exciting coil in advance so that the rotor rotates in a reverse rotational direction to an angle where an inductance increases so that the rotor rotates in the intended rotational direction, and after the angle where the inductance increases so that the rotor rotates in the intended rotational direction has been reached, the pulse current is provided.

In the method for controlling the brushless DC motor having such a structure, when the stop position of the rotor is a position where starting torque for rotation in the intended rotational direction cannot be obtained, the brushless DC motor is initially rotated in the reverse direction, and then driven in the originally intended rotational direction after the brushless DC motor has entered a state in which starting torque can be obtained. Thus, the brushless DC motor can be more reliably started.

In another form of implementation, in these above-described methods for controlling brushless DC motor, after the rotor has been started to rotate, only in an angular region where an inductance increases so that the rotor rotates in the intended rotational direction, a current of the same sign as the rotational direction (positive current for positive rotation and negative current for negative rotation) is caused to flow through the exciting coil, thereby maintaining a rotational speed at which the rotor is rotated in the intended rotational direction.

In another form of implementation, in these above-described methods for controlling brushless DC motor, a current is caused to flow through the exciting coil. This current has a start-up time and a wave height that are sufficient to cause the rectifier cells of the induction coils to be turned on and that has a polarity corresponding to the intended rotational direction. With the flow of this current, one of torque control corresponding to load torque and high-speed rotation control at a speed exceeding a rated number of rotations with small load torque is able to be performed.

The present application is filed on the basis of Japanese Patent Application No. 2010-250843 filed on Nov. 9, 2010, the contents of which is incorporated herein.

Although the present invention has been adequately and sufficiently described through the embodiment with reference to the drawings in order to express the present invention, it should be appreciated that those skilled in the art can easily modify and/or improve the above-described embodiment. Accordingly, it should be understood that, unless modified or improved embodiments implemented by those skilled in the art are departing from the scope of rights claimed in the CLAIMS, the modified or improved embodiments are included in the scope of the claimed rights.

### INDUSTRIAL APPLICABILITY

According to the present invention, a brushless DC motor can be provided.

1. A brushless DC motor comprising:
a stator that includes a single exciting coil; and
a rotor provided coaxially with the stator inside the stator;
wherein the rotor has a base portion and a plurality of protrusions that serve as magnetic poles, the protrusions radially extending outward from the base portion so as to be equally spaced apart from one another in a peripheral direction,
wherein the stator includes the annular exciting coil, annular main bodies disposed on one and the other side of the exciting coil in a rotational axis direction, and first and second magnetic cores each having a plurality of protrusions that serve as magnetic poles and radially extend inward from the main body so as to be arranged in the peripheral direction,
wherein the numbers of protrusions of the first and second magnetic cores are different from each other, and
wherein variation in magnetic resistance between the stator and the rotor with respect to a flow of a magnetic flux generated around the exciting coil is used as a driving force.

2. The brushless DC motor according to claim 1,
wherein the number of the protrusions of the first magnetic core is the same as the number of the protrusions of the rotor,
wherein the number of the protrusions of the second magnetic core is twice the number of the protrusions of the rotor,
wherein an induction coil that includes a loop-shaped conducting member and a rectifier cell arranged in the conducting member is provided around each of the protrusions of the second magnetic core, and
wherein the rectifier cells are arranged so that the rectifier cells of the adjacent magnetic poles limit flows of current in directions opposite to each other.

3. The brushless DC motor according to claim 2,
wherein the protrusions of the second magnetic core are arranged such that, in a pair of the protrusions, one and the other protrusions are equally shifted in the peripheral direction from a corresponding one of the protrusions of the first magnetic core disposed at the center of the one and the other protrusions.

4. The brushless DC motor according to claim 2,
wherein, in a cylindrical plane defined by loci of tips of protrusions of the rotor, a length of the tips in the peripheral direction is from 50 to 65%.

5. The brushless DC motor according to claim 2,
wherein the exciting coil is formed by winding a band-like conducting member such that a width direction of the band-like conducting member extends in the rotational axis direction of the exciting coil.

6. The brushless DC motor according to claim 2,
wherein the conducting members of the induction coils are integrated together into a cage-shaped structure that includes support columns that extend in the rotational axis direction and are disposed on one and the other sides of the protrusions of the second magnetic core and two annular members disposed on upper and lower sides of the protrusions and connected to both ends of each support column, and wherein the rectifier cells are disposed in one of the annular members arranged between the first and second magnetic cores and the annular members surround around each magnetic pole.

7. The brushless DC motor according to claim 2,
wherein the first and second magnetic cores and the rotor are each formed of one of a dust core formed of an iron-based soft magnetic powder, a ferrite magnetic core, and a magnetic core formed of a soft magnetic material formed by dispersing a soft magnetic alloy powder in a resin.

8. The brushless DC motor according to claim 2,
wherein a plurality of the stators are stacked one on top of another in the rotational axis direction.

9. The brushless DC motor according to claim 2,
wherein the main body of at least one of the first and second magnetic cores has an L-shaped section in the peripheral direction.

10. A method for controlling the brushless DC motor according to claim 2, the method comprising:
starting the rotor in an intended rotational direction by providing the exciting coil with a pulse current that has a start-up time and a wave height that are sufficient to cause the rectifier cells of the induction coils to be turned on and that has a polarity corresponding to the intended rotational direction.

11. The method for controlling the brushless DC motor according to claim 10,
wherein, when the brushless DC motor is rotated from a position where an inductance characteristic generated between the stator and the rotor does not increase due to the rotational angle position of the rotor with respect to the intended rotational direction of the rotor, a current is caused to flow through the exciting coil in advance so that the rotor rotates in a reverse rotational direction to an angle where an inductance increases so that the rotor rotates in the intended rotational direction, and after the angle where the inductance increases so that the rotor rotates in the intended rotational direction has been reached, the pulse current is provided.

12. The method for controlling the brushless DC motor according to claim 10,
wherein, after the rotor has been started to rotate, only in an angular region where an inductance increases so that the rotor rotates in the intended rotational direction, a current of the same sign as the rotational direction is caused to flow through the exciting coil, thereby maintaining a rotational speed at which the rotor is rotated in the intended rotational direction.

13. The method for controlling the brushless DC motor according to claim 10,
wherein, by causing a current to flow through the exciting coil, the current being a current that has a start-up time and a wave height that are sufficient to cause the rectifier cells of the induction coils to be turned on and that has a polarity corresponding to the intended rotational direction, one of torque control corresponding to load torque and high-speed rotation control at a speed exceeding a rated number of rotations with small load torque is able to be performed.
